(19) United States
(12) Patent Application Publication
(10) Pub. No.: US 2018/0310684 A1
(43) Pub. Date: Nov. 1, 2018

(54) Carrying Bag With Iterchangeable Panels

(71) Applicant: James Randolph Fenton, Hermosa Beach, CA (US)

(72) Inventor: James Randolph Fenton, Hermosa Beach, CA (US)

(21) Appl. No.: 15/732,893

(22) Filed: Jan. 12, 2018

Related U.S. Application Data
(63) Continuation-in-part of application No. 14/121,066, filed on Jul. 25, 2014, now Pat. No. 9,901,150.
(60) Provisional application No. 61/958,359, filed on Jul. 26, 2013.

(51) Int. Cl. A45C 13/08; A45C 1/02; A45C 3/06; A45C 3/02; A45C 5/03; A45C 11/00; A45F 3/04; A45C 13/10; G10G 7/00

(52) U.S. Cl. CPC A45C 13/08; A45C 1/02; A45C 3/06; A45C 3/02; A45C 2003/007; A45C 11/00; A45F 3/04; A45C 13/1076; G10G 7/005; A45C 5/03

(57) ABSTRACT

A bag with attachable panels is disclosed. The attachable panels may include graphical images such that the panels may be interchanged to change the design on the bag. The bag may also include reinforcement panels. An in-store retail system to customize the graphics on the attachable panels is also disclosed.

### CROSS REFERENCE TO RELATED APPLICATIONS

This application is a Continuation In Part of U.S. patent application Ser. No. 14/121,066, filed Jul. 25, 2014, the entire contents of which are hereby fully incorporated herein by reference for all purposes. U.S. patent application Ser. No. 14/121,066 claims priority from U.S. Provisional Patent Application Ser. No. 61/958,359, filed on Jul. 26, 2013, the entire contents of which are hereby fully incorporated herein by reference for all purposes.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### FIELD OF THE INVENTION

The field of the invention generally relates to carrying bags and cases. More specifically, the invention relates to carrying bags that may have attachable, removable and interchangeable outer panels with printed graphics or pictures. The field of the invention also generally relates to an in-store retail system and method to customize the graphics on the interchangeable panels.

### BACKGROUND OF THE INVENTION

There are many different types of carrying bags and cases on the market in the world. Some examples are 1) backpacks that may be used by students or others to carry books and other supplies, 2) business and computer bags used to carry laptops and other business supplies, 3) sports bags used to carry sporting goods, 4) musical instrument bags used to carry musical instruments and 5) travel bags and luggage to carry personal belongings. In addition to these examples, there are many other types of carrying bags on the market throughout the world.

In one example, musical instrument carrying bags and cases typically come in a variety of shapes and sizes depending on the types of musical instrument they are designed to hold. The bags and cases may also come in a variety of types, specifically, hard, soft, or hybrid type cases. Hard cases may comprise an outer shell that is hard and rigid, and may be made of harder materials such as plastic, metal such as aluminum, pressed leather or other harder materials. Soft cases, often referred to as gig bags, may comprise an outer shell that is softer and less ridged than a hard case, and may be made of softer materials such as polyester fabric, nylon fabric, canvas, softer leather or other materials. Often, these softer materials may be lined with a thin PVC or PU lining in order to add a small level of rigidity and durability to the shell. Hybrid cases are typically a combination of a hard case and a soft case, and may utilize a softer outside shell with a more rigid inner padding to increase the level of protection that the bag may provide to the musical instrument.

The cases and bags often also include a layer of foam padding on the interior of the case or bag on one or more sides to provide increased protection to the musical instrument that may be contained inside. The foam padding may protect the musical instrument inside the case if the case were to be dropped or were to receive a blow from a blunt object. The cases and bags often also include pockets on the front panel of the bag or case to carry musical sheets and binders, as well as other accessories such as picks, cords and straps. In addition, many musical instrument carrying bags and cases include side handles to carry the bag or case with one hand, and back pack straps on the back of the bag to secure the bag over the user's shoulders as a backpack would be secured and carried.

Many musical instrument bags and cases on the market currently are made of a single colored material, predominantly black. Others may use materials of other colors and a few may have colored graphics printed on the bags. However, these bags and cases are typically limited in variety and the colors and graphics are applied to the bags in a permanent fashion; that is, the colors and the graphics cannot be removed or changed.

It should be noted that creative people such as musicians may wish to express themselves and their own unique personalities by having graphics and artwork on their musical instrument bags and cases. However, there are no musical instrument bags that allow the user to apply a wide variety of graphics to the bags, or that allow the user themselves to apply their own colorful graphics or logos to the bags in a high quality manner.

In addition, the user may wish to express themselves with a particular graphic or logo on their bag one day, and then may wish to express themselves differently the next day with a different graphic or logo on their same bag. However, there are no musical instrument bags or cases that allow the user to change the graphics or logos on the bag or case as desired. In addition, having multiple bags that may have different graphics that may be used to express themselves differently may become costly due to the high cost of the bags. Also, musical cases and bags are often somewhat large, and having multiple bags may require a large amount of storage space to store the different bags when not in use.

The same may be said for other types of carrying bags such as backpacks, business and computer bags, sports bags, travel bags and other types of carrying bags. That is, the owners of these types of bags, as well as other types of bags not mentioned, may also be interested in expressing themselves with graphics and artwork on their carrying bags similar to musicians with their musical bags. And they too may wish to express themselves with one particular graphic design on their carrying bag on one day and a different graphical design on their carrying bag on another day.

From a manufacturing and business standpoint, it may be costly for a manufacturer of carrying bags to produce inventories of carrying bags with particular designs on them to sell to retail outlets and direct to customers. It may also be risky for a manufacturer of carrying bags to pick one or several designs to produce and to produce inventories of these particular designs in hopes that the carrying bags with these particular designs will be popular designs and will sell. If the designs are not popular, or fall out of popularity before the entire inventory is sold, the manufacturer may be stuck holding inventory of carrying bag designs that are no longer sellable and may be required to liquidate the inventory at a financial loss.

From a retailer's standpoint, it may be profitable to have an in-store system that allows the customers to customize, order and purchase custom printed interchangeable panels for bags they may purchase in-store.

Accordingly, there is a need for an improved carrying bag or case of different types as described above that addresses the foregoing and other issues. There is also a need for an in-store system and method for customizing interchangeable panels.

### BRIEF DESCRIPTION OF THE DRAWINGS

Various other objects, features and attendant advantages of the present invention will become fully appreciated as the same becomes better understood when considered in conjunction with the accompanying drawings, in which like reference characters designate the same or similar parts throughout the several views, and wherein:

FIG. 1 depicts aspects of a bag;

FIG. 2 depicts aspects of an attachable panel;

FIG. 3 depicts aspects of a bag with an attachable panel;

FIGS. 4-5 depict aspects of a bag;

FIG. 6 depicts aspects of a bag and an attachable panel;

FIG. 7 depicts aspects of a bag;

FIGS. 8-9 depict aspects of an attachable panel;

FIG. 10 depicts aspects of an alignment step;

FIG. 11 depicts aspects of an attachment step;

FIG. 12 depicts aspects of an upper flap on a bag;

FIG. 13 depicts aspects of an attachable panel;

FIG. 14 depicts aspects of an attachable panel and a bag;

FIG. 15 depicts aspects of an attachable panel and a bag;

FIG. 16 depicts aspects of an upper flap on a bag;

FIG. 17 depicts aspects of a bag and an attachable panel;

FIG. 18A depicts aspects of a bag and an attachable panel;

FIGS. 18B-18C depict aspects of an attachment mechanism;

FIG. 19 depicts aspects of a bag and an attachable panel;

FIG. 20A depicts aspects of of a bag;

FIG. 20B depicts aspects of an attachable panel;

FIG. 21 depicts aspects of a bag with an attachable panel;

FIG. 22 depicts aspects of a bag and an attachable panel;

FIG. 23 depicts aspects of an attachable panel;

FIG. 24 depicts aspects of an attachable panel on a pad;

FIG. 25 depicts aspects of a customization system; and

FIG. 26 is a logical block diagram depicting aspects of a computer system.

Other aspects of the invention are discussed herein.

Other features and advantages of the present invention will become apparent from the following more detailed description, taken in conjunction with the accompanying drawings, which illustrate, by way of example, the principles of the invention.

### DETAILED DESCRIPTION OF THE PREFERRED EMBODIMENTS

As used herein, unless used otherwise, the following terms or abbreviations have the following meanings:

A “mechanism” refers to any device(s), process(es), routine(s), service(s), or combination thereof. A mechanism may be implemented in hardware, software, firmware, using a special-purpose device, or any combination thereof. A mechanism may be integrated into a single device or it may be distributed over multiple devices. The various components of a mechanism may be co-located or distributed. The mechanism may be formed from other mechanisms. In general, as used herein, the term “mechanism” may thus be considered to be shorthand for the term device(s) and/or process(es) and/or service(s).

There are many different types of carrying bags and cases being sold throughout the world. Examples of these different types of carrying cases and bags include musical instrument bags and cases, backpacks, laptop bags and cases, business cases, purses, phone cases, tablet computer cases, travel cases and luggage, sports bags and many other types of carrying bags and cases. Because there are so many different types of bags and cases on the global market, this specification will begin by describing the invention as it relates to musical instrument carrying bags and cases, specifically guitar bags and cases, and will then continue with a description of how the invention relates to other types of carrying cases and bags such as backpacks, messenger bags, sports bags, business and computer bags, purses, travel bags and other types of carrying bags.

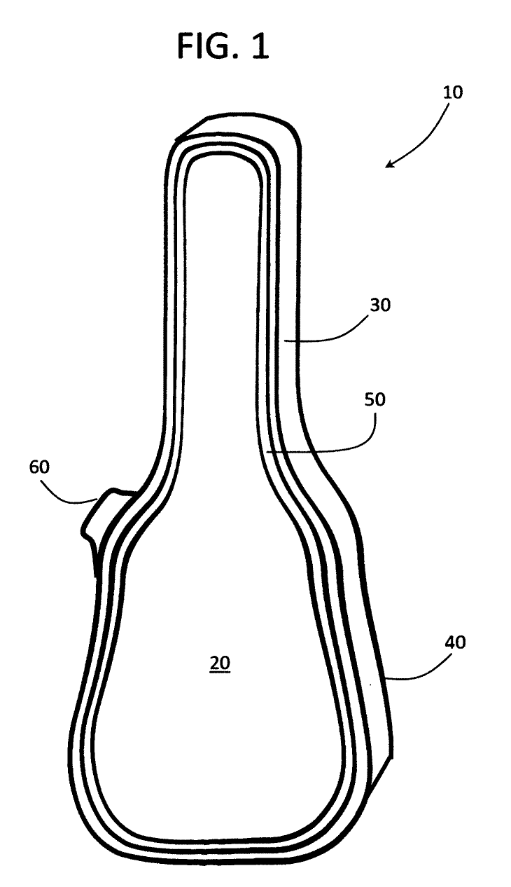

A preferred embodiment of the current invention is now described with reference to FIG. 1. FIG. 1 shows a front view of a case or bag 10 that may be designed to carry a guitar. The guitar may be an acoustic guitar, an electric guitar or other type of guitar. Components appearing in more than one figure are identified by the same reference numeral.

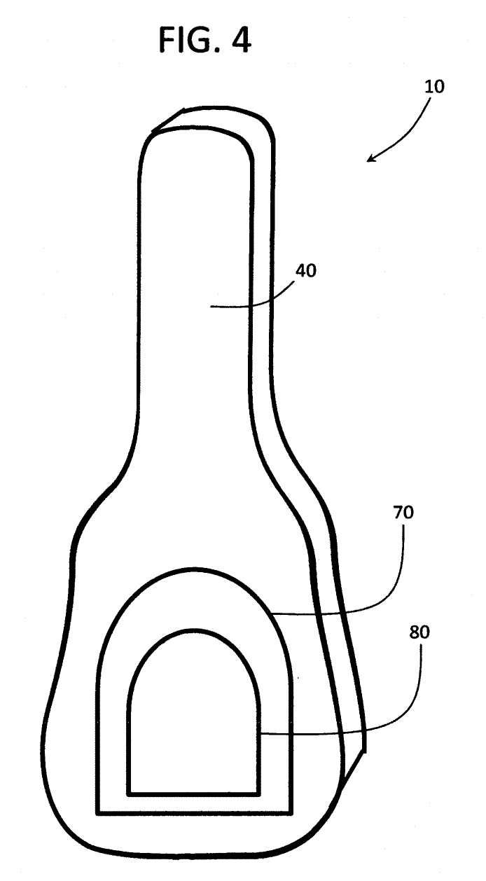

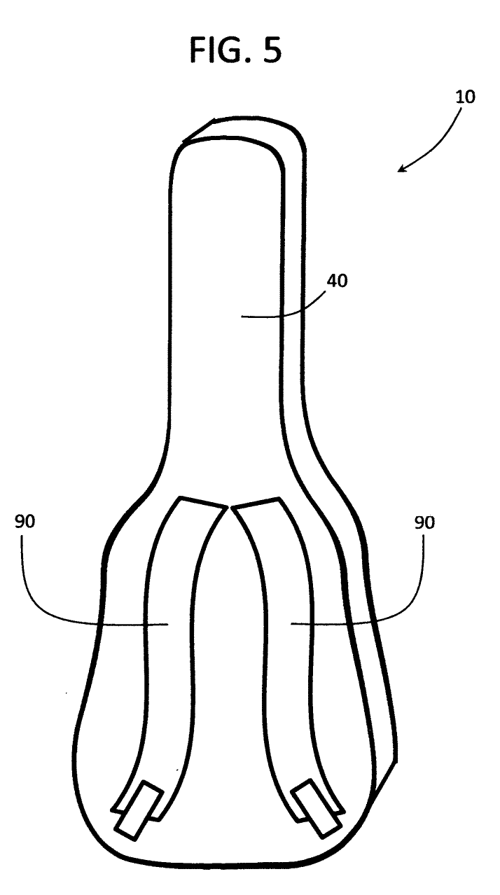

As shown in FIG. 1, FIG. 4 and FIG. 5, guitar bag 10 may include front panel 20, side panel 30, back panel 40, front hook and loop section 50, side handle 60, pockets 70, 80 and backpack straps 90. Guitar bag 10 may be generally configured to receive a musical instrument such as a guitar in order to protect the instrument during travel or storage, and may provide holding means for the user to carry the bag such as side handle 60, backpack straps 90 or other means. In addition, front panel 20 may include a side zipper (not shown) that may be opened in order to partially or fully separate front panel 20 from side panel 30 in order to insert the guitar into the bag 10, and that may be closed to secure the instrument inside. As shown in FIG. 5, guitar carrying case may include backpack type straps on the back of the bag 10 such that the guitar carrying case 10 may be worn like a backpack for hands-free carrying. Pockets 70, 80 as shown in FIG. 4 may be configured on the back of the guitar carrying case as shown to hold items such as sheet music, tablet and laptop computers, cables, picks and other accessories and items. While pockets 70, 80 are shown to be located on the back of the guitar carrying bag in order to leave the front side 130 of the carrying case free of these elements, pockets may also be located in other areas and on other sides of guitar carrying case 10.

In one embodiment as shown in FIG. 1, hook and loop section 50 may include a strip of either loop fastener material or hook fastener material that may be sewn or attached by other means around the general circumference of front panel 20. The hook and loop fastener material may be VELCRO™ brand hook and loop material, or hook and loop material from other manufactures. In a preferred embodiment, hook and loop strip 50 may be 0.5 inches wide, but other widths may also be used.

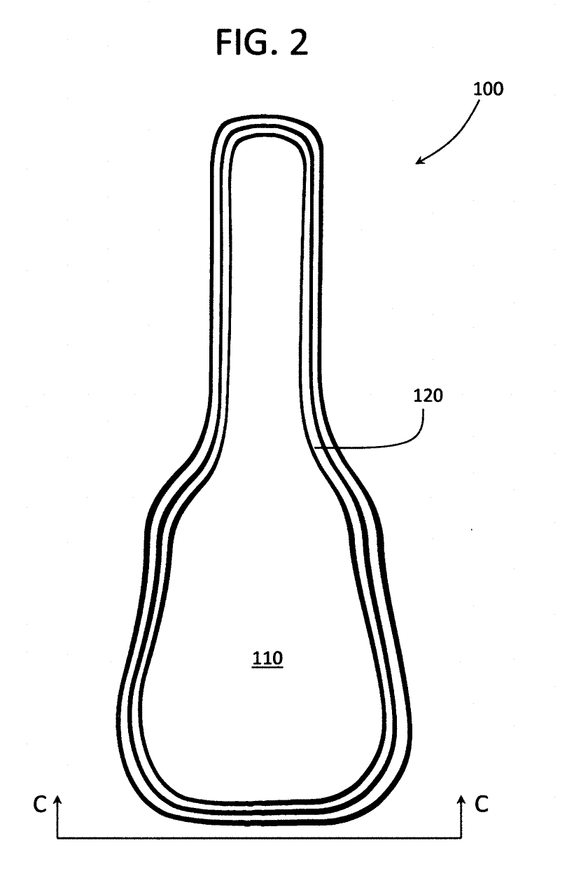

Hook and loop section 50 may be configured to receive and attach to hook and loop section 120 that may be sewn or attached by other means around the general circumference of back side 110 of detachable panel 100 as shown in FIG. 2. As will be described in further detail in later sections, attachable panel 100 may have a front side 130 (not shown) and a back side 110 that may generally correspond in size and shape to front panel 20 of bag 10. In addition, detachable panel 100 may comprise of a rugged material similar to the material used to manufacture the instrument bag such as polyester, nylon, canvas or other materials. Also, attachable panel 100 may include a liner material adhered to its back side 110 that may add stiffness to the attachable panel 100. In a preferred embodiment, front side 130 of attachable panel 100 may contain graphics, pictures or other artwork that may be chosen or created by the user in order to express themselves through aesthetic means.

Attachable panel 100 may be secured to front panel 20 of gig bag 10 by placing attachable panel 100 onto front panel 20 such that hook and loop section 50 and hook and loop section 120 may generally align face-to-face, and by pressing hook and loop section 120 onto hook and loop section 50 such that they may mate and adhere to one another. It may be preferable that if hook and loop section 50 may be a loop type of hook and loop fastener, that hook and loop section 120 may be a hook type of hook and loop fastener such that the two hook and loop sections may mate and adhere to one another when aligned and pressed together. It may also be preferable that if hook and loop section 50 may be a hook type of hook and loop fastener, that hook and loop section 120 may be a loop type of hook and loop fastener such that the two hook and loop sections may mate and adhere to one another when aligned and pressed together.

As shown in the illustrated embodiment of FIG. 1, hook and loop section 50 may be a generally continuous strip of hook and loop fastening material that may extend around the general circumference of front panel 20 of guitar bag 10. While FIG. 1 shows hook and loop section 50 as extending continuously around the general circumference of the front panel 20, the hook and loop section 50 may not be continuous and may be in sections.

In addition, hook and loop section 50 may be sewn or otherwise attached to other locations on front panel 20 such as in the inner region instead of along the circumference. Also, hook and loop strip 50 may be located in a variety of locations that may include the circumference, the inner regions and other regions of front panel 20.

While FIG. 1 depicts hook and loop section 50 as generally being a strip, other shapes or patterns of hook and loop may be used such as square patches, circular patches, and other shapes or patterns of hook and loop that may be located in various locations on front panel 20.

In addition, as shown in FIG. 2, hook and loop section 120 may be a generally continuous strip of hook and loop tastening material that may extend around the general circumference of back side 110 of attachable panel 100. While FIG. 2 shows hook and loop section 120 as extending continuously around the general circumference of the back panel 110 of attachable panel 100, the hook and loop section 120 may not be continuous and may be in sections.

Also, hook and loop section 120 may be sewn or otherwise attached to other locations on back side 11 0 of attachable panel 100 such as in the inner region instead of along the circumference. Also, hook and loop strip 120 may be located in a variety of locations that may include the circumference, the inner regions and other regions of back side 110 of attachable panel 100.

While FIG. 2 depicts hook and loop section 120 as generally being a strip, other shapes or patterns of hook and loop may be used such as square patches, circular patches, and other shapes or patterns of hook and loop that may be located in various locations on back side 110 of attachable panel 100.

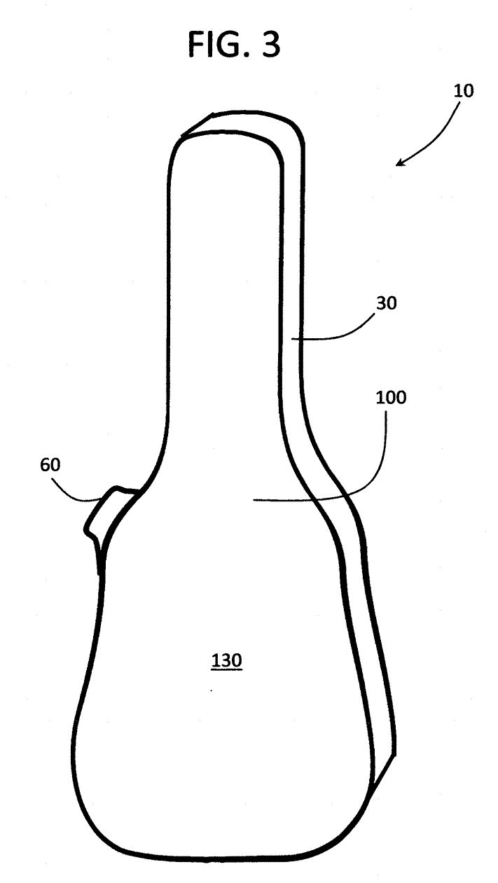

It may be preferable that at least some of the hook and loop sections 120 on back side 110 of attachable panel 100 may align with at least some of the hook and loop sections 50 on front panel 20 of bag 1 0 when attachable panel 100 is generally placed onto front panel 20 of bag 10 and the shape of attachable panel 100 is generally aligned with the shape of front panel 20 of bag 10. In this generally aligned position, attachable panel 100 may be pressed onto front panel 20 of bag 10 such that such that at least some of the hook and loop sections 50 on front panel 20 of bag 10 may mate and adhere to at least some of the hook and loop sections 120 on the back side 110 of attachable panel 100. In this configuration attachable panel 100 may be secured to the front face 20 of the instrument bag 10. The resulting combination of the back side 110 of attachable panel 100 mated and secured to the front panel 20 of instrument carrying bag 10 as described above is shown in FIG. 3.

As shown in FIG. 3, the front side 130 of detachable panel 100 may be exposed and may generally cover the front panel 20 of instrument bag 10. In this configuration, front side 130 of attachable panel 100 may contain graphical artwork, logos, printed pictures, or other types of images (not shown) that may be used to add aesthetic value to the instrument bag.

It should be noted that attachable panel 100 may be removed by pulling the attachable panel 100 away from front face 20 of gig bag 10 with adequate force to break the mating bond between hook and loop sections 50 and 120, In this way, one attachable panel 100 that may have specific graphical artwork printed on its front side 130 may be removed and replaced with another attachable panel 100 that may have different graphical artwork printed on its font side 130. As such, the attachable panels 100 are interchangeable. The procedure to do this may be for the user to pull an existing detachable panel 100 off the front panel 20 of bag 1 0 by gripping the detachable panel 100 and pulling it away from the front panel 20 of bag 10 to release attachable panel 100 from bag 10. The user may then generally align the shape of a new attachable panel 100 with the shape of front panel 20 of bag 10 and may press attachable panel 100 to front panel 20 of bag 10 to attach new attachable panel 100 to bag 10. In this fashion, the user may remove and replace attachable panels 100 as they desire in order to change the graphical design shown on their carrying case at any time. The user may also purchase or otherwise acquire additional attachable panels 100 with brand new designs at any time to continually increase the selection of designs that they may attach to their carrying cases and bags.

It should also be noted that while FIG. 3 shows the attachable panel 100 as generally resembling the size and shape of front panel 20 of instrument bag 10, attachable panel 100 may not generally resemble the size and shape of front face 20 (not shown). In one example of this type, attachable panel 100 may cover only a portion of front face 20 and may therefore be any shape. In this embodiment it may be preferable that attachable panel 100 may fit generally within the entire or a portion of the outer contour of front face 20 but this may not be required. It may also be preferable that attachable panel 100 not extend past the outer circumference of front face 20 of bag 10, but this may not be required. In addition, attachable panel 100 may be modified to fit within the contour of front panel 20 by folding, cutting or other modification techniques.

Graphical artwork may be printed on or otherwise affixed to the front side 130 of attachable panel 100 using a digital printing machine, a dye sublimation system, silk screening techniques, paint, decals, stickers or other means so that the customer may express themselves aesthetically through the artwork they choose for their bag.

While the descriptions thus far of the attachable panel 100 of FIG. 2 and the instrument bag 10 of FIG. 1 have mainly described the attachable panel 100 being removably attached to the front panel 20 of the instrument bag 10 by using VELCRO fastening mechanisms and/or means, other means such as clips, pins, buttons, snaps, zippers, latches, grommets, magnets or other means may also be used. In these examples, the fastening mechanisms and/or means may be a part of the instrument bag 10 and the attachable panel 100 as described above with respect to using VELCRO as the attachment means. Or, the attachment means may be a part of the instrument bag 10 only, the attachable panel 100 only, neither the bag 10 nor the attachable panel 100, or any combination thereof. In addition, the fastening mechanisms and/or means may or may not remain as a part of the bag 10 or the attachable panel 100 when the attachable panel 100 may be removed.

For instance, in one embodiment, attachable panel 100 may be attached to the front panel 20 of bag 10 using a side zipper. That is, one side of the zipper may be attached around the general circumference of the attachable panel 100 and the other side of the zipper may be attached around the general circumference of the front panel 20 of the bag 10 such the two sides of the zipper may be zipped together to secure attachable panel 100 to the front panel 20 of bag 10. In addition, the zipper may secure attachable panel 100 to bag 10 by being located in other areas on carrying bag 10 different than the circumference of bag 10, located in other areas on attachable panel 100 different than the circumference of attachable panel 100, or in any combination of circumference areas and non-circumference areas on bag 10 and attachable panel 100.

In another embodiment, attachable panel 100 may be attached to the front panel 20 of bag 10 using snaps. That is, male sides of snaps may be positioned on the front panel 20 of the bag 10, and female sides of snaps may be positioned in corresponding positions on attachable panel 100 such that when attachable panel 100 is generally aligned in position on front panel 20 of bag 10, the male and female snap components may align and engage to affix panel 100 to front panel 20 of bag 10. It may be preferable that if male sides of snaps are configured on the front panel 20 of bag 10 that female sides of snaps are configured in corresponding positions on detachable panel 100, and that if female sides of snaps are configured on the front panel 20 of bag 10 that male sides of snaps are configured on the attachable panel 20.

As described above, other attachment mechanisms may also be used to configure attachable panel 100 to front panel 20 of bag 10 such as latches and grommets, buttons, pins, sewing methods, clips, rivets, magnets and other means.

In yet another embodiment, the attachable panel 100 may serve as the complete front panel 20 or as a part of the front panel 20 of the bag 10 such that all or a portion of the attachable panel 100 and all or a portion of the front panel 20 of the bag 10 may be one in the same. That is, a portion or the entirety of front panel 20 of bag 10 may comprise the attachable panel 100 and may be removed and replaced by another front panel 20 with different graphical artwork affixed to it. In this embodiment, the front panel 20 may be attached to the bag 10 with a zipper as described above, hook and loop, snaps, clips or other means.

It should be noted that the invention described above may apply to all types of guitar cases and bags including hard cases, soft cases, gig bags, hybrid cases and bags, and other types of guitar bags and cases. Depending on the type of case, it may be preferable that different types of attachment means may be used to affix attachable panel 100 to front panel 20 of case 10. For instance, for soft cases and hybrid cases, hook and loop may be used as described above. However, for hard cases made of metal for example, magnets, snaps, latches or other means may be preferable.

It should also be noted that while the descriptions above describe the attachable panel as being attached to the front side 20 of the guitar gig bag 10, the attachable panel 100 may also be attached to other sides or panels of the instrument bag 10 such as the side panel 30, the back panel 40, or to any other panels or sides, or to any combination of panels or sides of carrying case 10, or to any other area on carrying case 10.

Also, while the above descriptions describe a single attachable panel 100 being attached to a carrying case or bag 10, multiple attachable panels may be attached to the carrying case or bag 10 individually or in unison using similar or different means as described above. Said multiple detachable panels may be attached to the front sides, side sides, back sides, or any other sides, regions, areas or combination of sides, regions and areas on the carrying case 10.

In addition, while the description above primarily describes the attachment of attachable panel 100 to a guitar carrying bag or case 10, the attachable panel 100 may be attached to or otherwise generally configured with other types of bags meant for carrying other types of instruments. Examples of this may include drum cases, drum stick cases, keyboard cases, horn cases, woodwind cases, violin cases and other types of musical instrument cases.

Also, the attachable panel 100 may be attached to or otherwise generally configured with other types of cases and bags that may be designed to carry other items or devices other than musical instruments. Such cases and bags may include laptop computer cases, personal backpacks, messenger bags, computer bags, tablet computer cases, tablet sleeves, purses, phone cases, travel cases, duffle bags, sports bags, overnight bags and other types of cases and bags. In one example, the attachable panel 100 may be configured with the front side of a backpack or a duffle bag using the same mechanisms and techniques as described above in regards to the attachable panel 100 being configured with the front side 20 of the guitar bag 10.

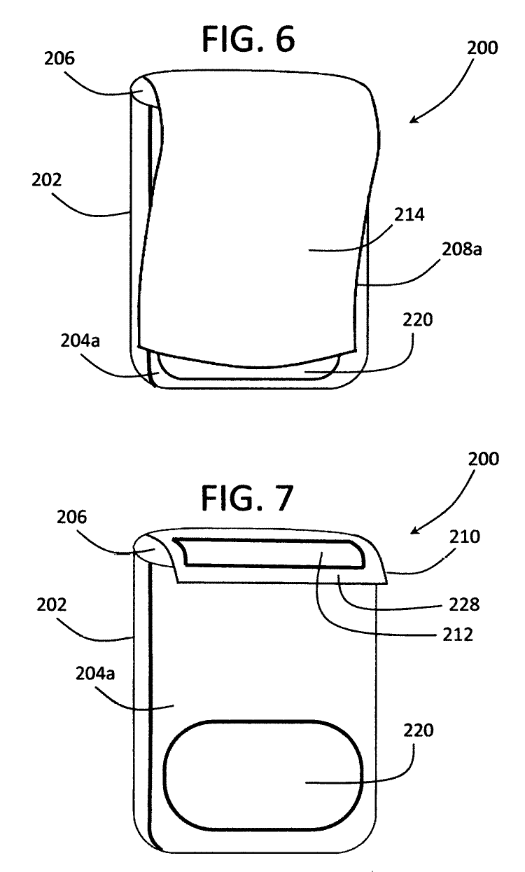

In another embodiment of a different type of carrying case or bag that may utilize an attachable panel, a backpack 200 as shown in FIG. 6 may include a body 202, a front side 204a, a top opening 206, a front pocket 220, an attachable panel 208a that is interchangeable and other components. Backpack may also include standard backpack-type straps (not shown) on the back of the bag 200 such that backpack 200 may be worn over the shoulders for hands-free carrying.

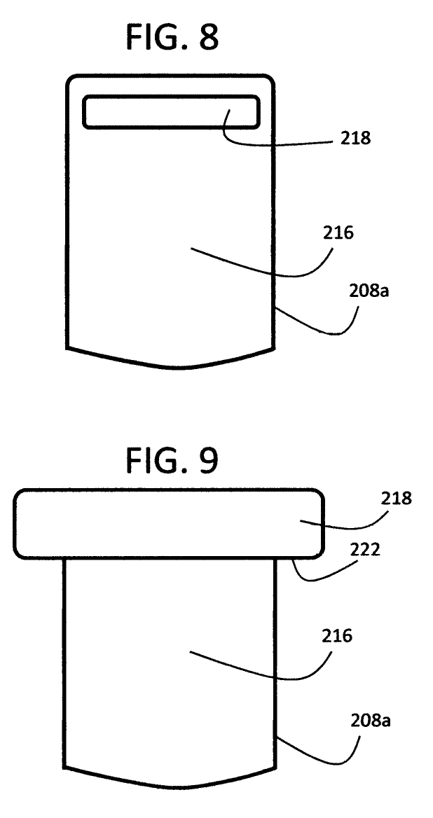

As shown in FIG. 7, backpack 200 may also include a top flap 210. Top flap 210 may include a hook and loop section 212 on its outer front side 228 as shown. As shown in FIG. 8, attachable panel 208a may include a hook and loop section 218 on its back side 216. In a preferred embodiment, hook and loop section 212 on flap 210 of backpack 200 may be configured in position, size and shape to receive hook and loop section 218 on the back side 216 of attachable panel 208a. When hook and loop sections 212 and 218 are mated accordingly, attachable panel 208a may be configured onto backpack 200 as shown in FIG. 6. It may be preferable that if hook and loop section 212 is the hook side of hook and loop, that hook and loop section 218 may be the loop side of hook and loop such that when hook and loop section 212 and hook and loop section 218 are pressed together that they may affix to each other. Conversely, it may be preferable that if hook and loop section 212 is the loop side of hook and loop, that hook and loop section 218 may be the hook side of hook and loop such that when hook and loop section 212 and hook and loop section 218 are pressed together that they may affix to each other. Pressing hook and loop section 218 of attachable panel 208aa of FIG. 8 to mate with hook and loop section 212 of FIG. 7 may result in backpack 200 configured with attachable panel 208a as shown in FIG. 6.

It should be noted that flap 210 may be incorporated into the back side, front side, side sides or other sides of the backpack 200 and may not resemble a flap as shown in FIG. 7. Instead, flap 210 may be a portion of the back side, front side or other sides of the backpack. In this scenario, hook and loop section 212 may be located on the back side, front side, side sides or other sides of the backpack 200.

With hook and loop section 212 mated and attached to hook and loop section 218, attachable panel 208a may be configured with backpack 200 and may generally extend from flap 210 over top opening 206 and down over the front 204a of backpack 200.

In this configuration, attachable panel 208a may act as the top of backpack 200 and may cover top opening 206 of backpack 200. Attachable panel 208a may also extend down the front 204a of backpack 200 and may or may not cover front pocket 220.

In addition, the lower region of detachable panel 208a may be attached or otherwise secured to front side 204a, or to other sides of backpack 200, using hook and loop, clips, snaps, buckles, straps with buckles, or other attachment means (not shown). With the lower region of detachable panel 208a affixed or otherwise secured to the front side 204a or other sides of backpack 200 in addition to the upper region of detachable panel 208 being affixed to flap 210 as described above, attachable panel 208a may act as a protective cover for backpack 200, thus securing any contents within backpack 200 safely inside. Also, top opening 206 may include additional means to be securely held closed such as a zipper or multiple zippers, snaps, clasps, hook and loop sections, a pull chord, latches or other securing means (not shown).

Note that the attachable panel 208a may be attached to the attachment flap 210 using other types of attachment mechanisms such as snaps, latches, zippers or other types or combinations of types of other attachment mechanisms. In one example, the attachable panel 208a may be attached to the attachment flap 210 using snaps. That is, male sides of snaps may be positioned on the top surface 228 of the flap 210, and female sides of snaps may be positioned in corresponding positions on top end of the attachable panel 208a such that when the top end of the attachable panel 208a is generally aligned in position with the attachment flap 210, the male and female snap components may align and engage to affix panel 208a to front attachment flap 210 of the backpack 200. It may be preferable that if male sides of snaps are configured on the top of the attachment flap 210 that female sides of snaps are configured in corresponding positions on attachable panel 208a, and that if female sides of snaps are configured on the top of the attachment flap 210 that male sides of snaps are configured on the attachable panel 208a. Note also that the snaps may be configured on the underneath side of the attachment flap 210 such that the attachable panel 208a may be configured with the underside of the attachment flap 210 accordingly. In this example, it may or may not be necessary for the attachment flap 210 and the attachable panel 208a to also include hook and loop material in addition to the snaps or other types or combination of types of attachment mechanisms.

In another embodiment, attachable panel 208b may also include upper side flaps 222 that may extend outward on the left and right upper sides of attachable panel as shown in FIG. 9. As shown, hook and loop section 218 may extend onto side flaps 222. As described below, side flaps 222 may be used to provide additional strength to the bond between attachable panel 208b and upper flap 210 of backpack 200.

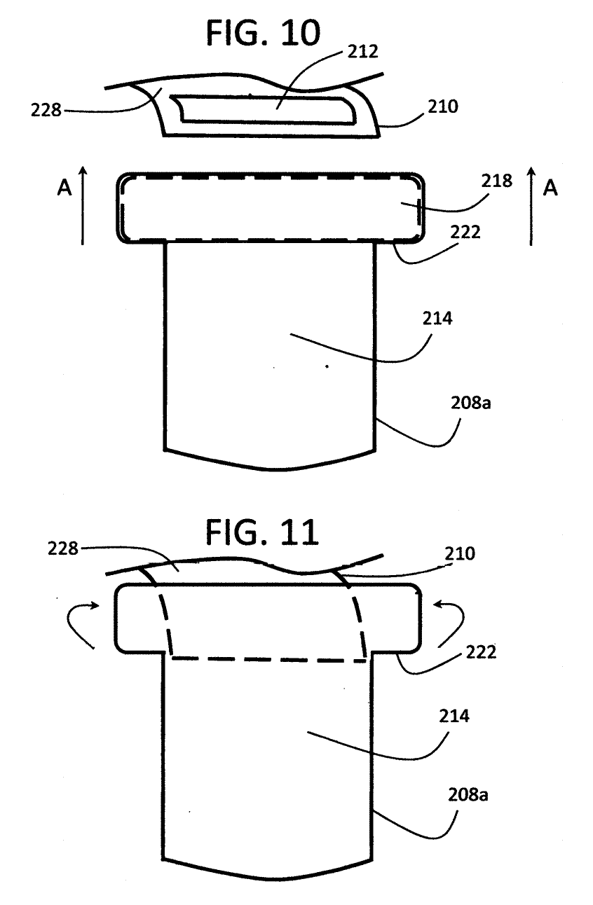

To secure attachable panel 208b to flap 210 while utilizing side flaps 222, attachable panel 208b may first be aligned with flap 210 as shown in FIG. 10. In this position, hook and loop section 218 on back side 216 of attachable panel 208b may be facing downward while hook and loop section 212 on upper flap 210 may be facing upward as shown. Attachable panel 208b may then be moved in the direction of arrows A in FIG. 10 until it may overlap upper flap 210 as shown in FIG. 11. In this position, hook and loop section 218 may be pressed onto hook and loop section 212 such that the two hook and loop sections may mate. It may be preferable that if hook and loop section 212 may be loop then hook and loop section 218 may be hook, and that if hook and loop section 212 may be hook then hook and loop section 218 may be loop.

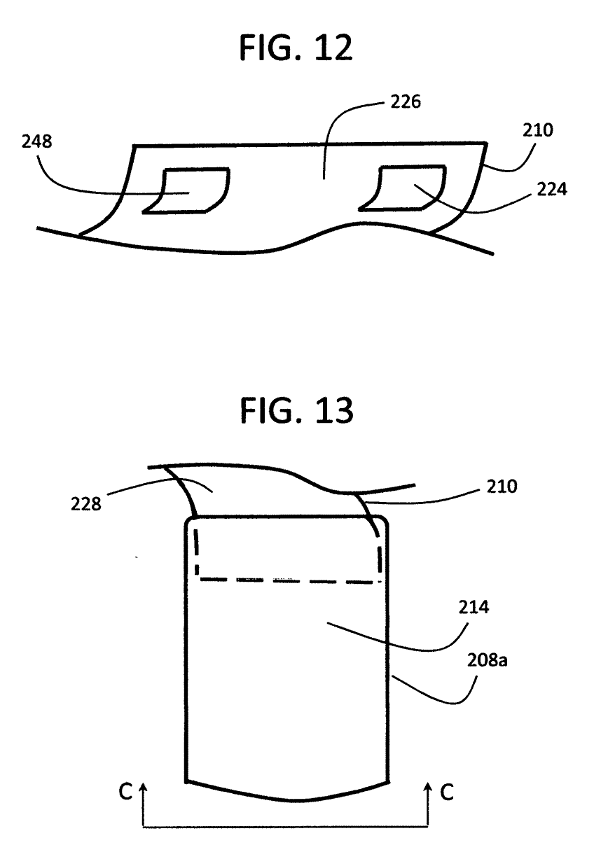

In this embodiment, it may also be preferable that upper flap 210 may have additional back hook and loop sections 224 on the general left and right regions on the back side 226 of upper flap 210 as shown in FIG. 12.

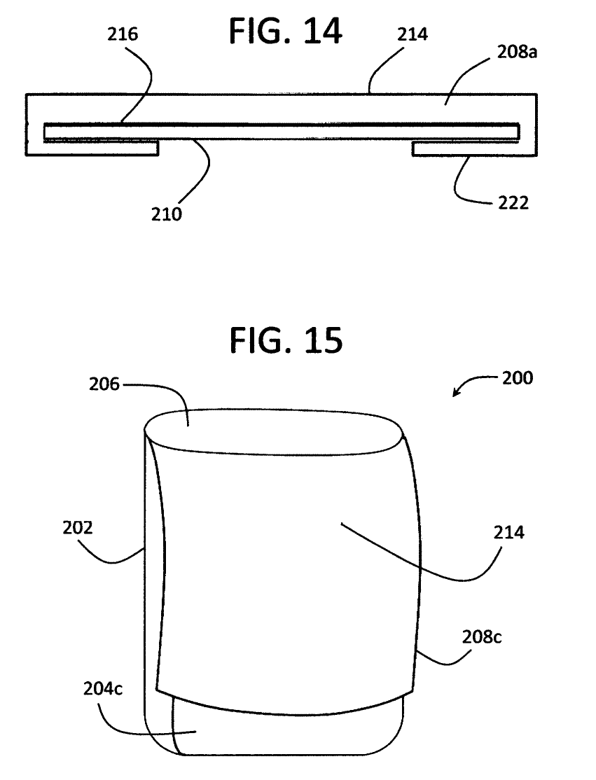

In the configuration as shown in FIG. 11, side flaps 222 may be folded over the edges of upper flap 210 until side flaps 222 may come into contact with the back side 226 of flap 210. In this position, it may be preferable that the outer portions of hook and loop section 218 on the left and right sides of side flaps 222 may come into contact and may mate with back hook and loop sections 224 on the back side 226 of upper flap 210. This is depicted in FIG. 13 and FIG. 14. FIG. 14 is a view looking in the direction of arrows B in FIG. 13.

It may be preferable that if hook and loop section 218 is the hook side, that hook and loop sections 224 may be the loop side such that when hook and loop section 218 and hook and loop sections 224 are pressed together that they may affix to each other. Conversely, it may be preferable that if hook and loop section 218 is the loop side, that hook and loop sections 224 may be the hook side such that when hook and loop section 218 and hook and loop sections 224 are pressed together that they may affix to each other. Pressing hook and loop section 218 on the side flaps 222 of attachable panel 208b of FIG. 8 to mate with hook and loop sections 224 of FIG. 7 may result in attachable panel 208b configured with flap 210 as shown in FIG. 13.

It should be stated that this configuration that may include side flaps 222 mated with the underside 226 of flap 210 via mated hook and loop sections 218 and 224 may allow attachable panel 208b to be attached to upper flap 210 of backpack 200 with increased strength. That is, in this configuration, it may be more difficult for attachable panel 208b to be accidentally pulled off from upper flap 210. Removing attachable panel 208b from this configuration may require that side flaps 222 may first need to be pulled away from the underneath back side 226 of flap 210 in order to disengage hook and loop sections 224 on the back side 226 of flap 210 from the outer areas of hook and loop section 218 on the back side 216 on the side flaps 222 of attachable panel 208b, and then the detachable panel 208b may be pulled off the front side 228 of upper flap 210 in order to disengage hook and loop section 218 on the back side 216 of detachable panel 208b from hook and loop section 212 on the top side 228 of flap 210.

It should be noted that the attachment mechanisms used to attach the side flaps 222 to the underside 226 of the attachment flap 210 may not be hook and loop material but may be other types of attachment mechanisms such as snaps, latches, hooks or other types of attachment mechanisms. In the example of using snaps, it may be preferable that the male or female component of the snaps may be configured with the underside 226 of the attachment flap 210 and the female or male components of the snaps be configured with the side flaps 222 respectively. In this way the snap components on the underside 226 of the attachment flap 210 may engage with the corresponding snap components on the side flaps 222. It may also be preferable that when side flaps 222 are folded over the sides of the attachment flap 210 as shown in FIG. 14, that the snap components that may be configured to the underside 226 of the attachment flap 210 may align with the corresponding snap components configured with the side flaps 222 such that the corresponding snap components on the underside 226 of the attachment flap generally engage with the corresponding snap components on the side flaps 222 to secure the attachable panel 208 to that attachment flap 210.

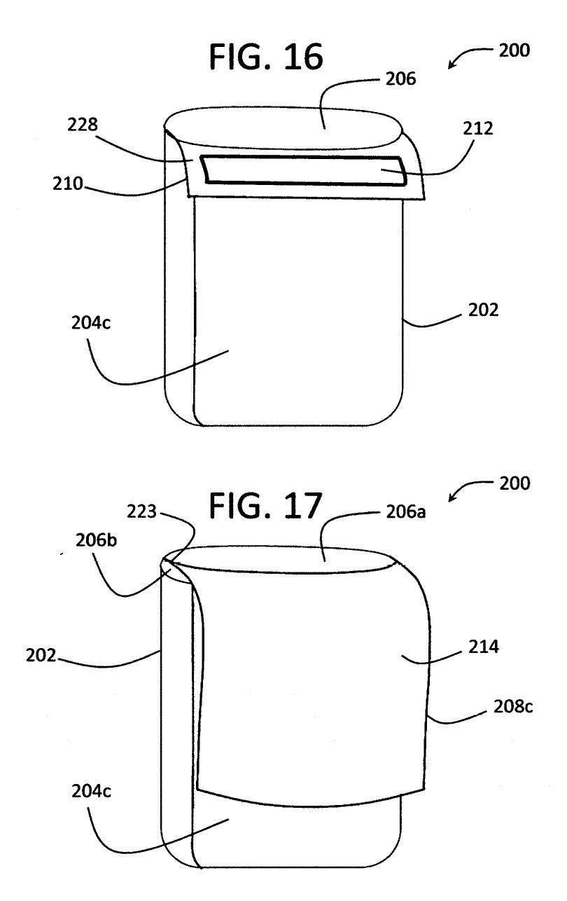

In addition, attachable panel 208c when configured with upper flap 210 may not cover top opening 206 of backpack 200 as shown in FIG. 15. Instead, upper flap 210 may be configured in front of or otherwise to the side of top opening 206 as shown in FIG. 16. Attachable panel 208c may be configured and attached to flap 210 using the methods described above, but with flap 210 positioned in front of top opening 206 instead of behind top opening 206, attachable panel 208c may not cover top opening 206 when configured with flap 210 of backpack 200 to extend from flap 210 down the front side 204c of backpack 200. In this case, top opening 206 may include additional means to be securely held closed such as a zipper or multiple zippers, snaps, clasps, hook and loop sections, a pull chord, latches or other securing means (not shown).

Also, backpack 200 may include multiple top openings 206 and attachable panel 208c may be configured to cover all multiple top openings 206, several of multiple top openings 206, one of multiple top openings 206 or no top openings 206. As an example, FIG. 17 depicts backpack with two top openings 206a, 206b separated by inner wall 222. As shown, attachable panel 208c may be attached using attachment means as described above or by Other means to the generally upper region of inner wall 222, or to a flap (not shown) configured with the generally upper section of inner wall 222, and may extend over front top opening 206a and down the front side 204c of backpack 200. In this example, attachable panel 208c may not extend over top opening 206a since attachable panel 208c may be attached to the top of inner wall 222 which may be positioned in front of top opening 206a. It may be understood however that if attachable panel 208c were attached behind top opening 206a, that it may extend over both top opening 206a and top opening 206b and down the front side 204c of backpack 200 (not shown). In addition, it may be understood that if attachable panel 208c were attached in front of top opening 206b, that it may extend down the front side 204c of backpack 200 but not extend over either top opening 206a or top opening 206b. It will be obvious to someone skilled in the art that this example may be scaled to carrying bags that may include multiple top openings greater in number than two and that attachable panel 208c may be configured to cover all multiple top openings, several top openings, one top opening or no top openings, depending on where the upper region of attachable panel 208c may be attached to backpack 200.

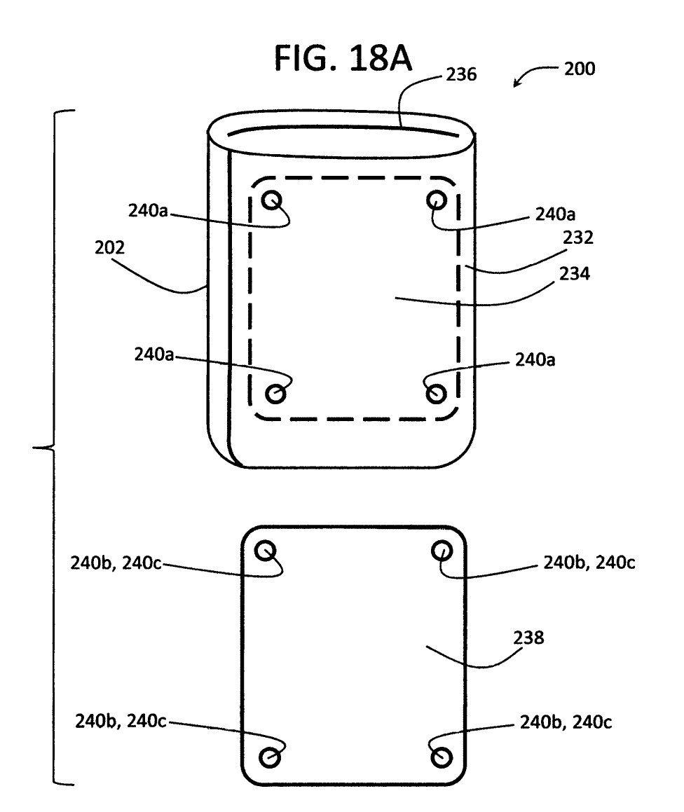

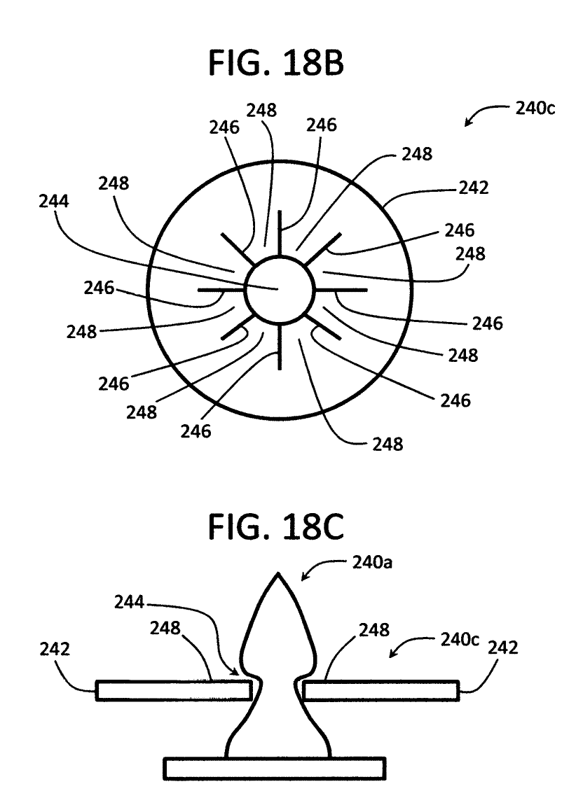

In another embodiment of a backpack 200 configured with an attachable panel 230 is shown in FIG. 18A. The backpack 200 may include a body 202, a front side 232, a reinforcement structure 234, a top opening 236 (depicted with a zipper), an attachable panel 238 that is interchangeable and other components. The backpack 200 may also include attachment mechanisms 240a (e.g. on its front side 232), and the attachable panel 238 may include corresponding attachment mechanisms 240b that may engage and generally attach to the attachment mechanisms 240a. Backpack 200 may also include standard backpack-type straps (not shown) on the back of the bag 200 such that backpack 200 may be worn over the shoulders for hands-free carrying.

The attachment mechanisms 240a and 240b may comprise snaps, latches, hook and loop material, rivets, and other types and/or combination of types of attachment mechanisms. In one example, the attachment mechanisms 240a and 240b may include snaps such that mechanisms 240a may be male or female snap components, and mechanisms 240b may be female or male snap components respectively. In this way the attachment mechanisms 240a and 240b may engage with each other. It may be preferable that when the attachable panel 238 is aligned with the section of the backpack 200 that it may be attached (e.g. the front side 232) that the each attachment mechanism 240a may align with a corresponding attachment mechanism 240b such that the mechanisms 240a and 240b may adequately engage and become secured. In this way, the attachable panel 238 may be configured, secured and generally attached to the front side 232 of the backpack 200.

While FIG. 18A depicts four attachment mechanisms 240a configured on the backpack 200 (e.g. one in each corner of the front side 232) and four corresponding attachment mechanisms 240b configured on the attachable panel 238 (e.g. one in each corner on the attachable panel 238), the backpack 200 and the detachable panel 238 may include any number of attachment mechanisms 240a, 240b in any location. The attachment mechanisms 240a, 240b may be configured in any location on the backpack 200 and in any corresponding location on the attachable panel 238 such that the attachable panel 238 and the backpack 200 may be configured together accordingly.

The attachment mechanisms 204a, 204b may also be hook and loop material 50 and 120 respectively as described in sections above in relation to bag 10 with front panel 20 and hook and loop section 50 that may be configured with attachable panel 100 with hook and loop section 120 (FIGS. 1-3). The attachment mechanisms 204a, 204b may include hook and loop sections that may be strips generally configured around the outer circumference of the front wall 232 and detachable panel 238 as described. The strips may be continuous or may be individual segments. Note that all of the details, characteristics and descriptions presented above with regards to FIGS. 1-3 are also within the scope of this example of FIG. 18A.

The reinforcement structure 234 (denoted as dashed line in FIG. 18A) may include a panel that may be configured with the backpack 200. The reinforcement panel 234 may comprise a stiff or a semi-stiff material such as Polyethylene (PE), High-Density Polyethylene (HDPE) or other types of plastics or materials. The panel 234 may be thin (e.g. 1 mm-3 mm thick) or may be thicker (e.g. greater than 3 mm thick) and may be configured with a surface of the backpack 200 (e.g. the front surface 232) upon which the attachable panel 238 may be attached). In this way, the reinforcement panel 234 may provide a rigid support structure to the surface 232 of the backpack 200 to properly support the attachable panel 238.

The attachable panel 238 may comprise a high quality material such as 600 denier Polyester which may add an amount of weight to the front surface 232 of the backpack 200 when the panel 238 may be attached to the front surface 232. Because the front surface 232 of the backpack 200 may not be stiff, and because the attachable panel 238 may add extra weight to the front wall 232 of the backpack 200, the front wall 232 may tend to droop, become concave inward, or may generally deform or become misshaped. This may be especially true for the upper portion of the front wall 232 of the backpack as it meets the top surface of the backpack 200. As such, the attachable panel 238 being attached or generally configured with the front wall 232 may also deform in a similar fashion. This may not be preferable since the attachable panel 238 may include graphics or other art or imagery on its outside surface that may be best viewed when the panel 38 may be generally flat and not misshaped. Accordingly, the reinforcement panel 234 may provide the added structure to the front surface 232 of the backpack 200 that may minimize the deformation of the front side 232 of the backpack and the detachable panel 238. Note that it may be preferable that the reinforcement structure 234 have sufficient thickness and stiffness to provide the adequate support necessary to minimize any deformations of the attachable panel 238 as described above.

The reinforcement structure 234 may be configured into the backpack 200 and the front surface 232 (or any other surface as desired) by generally configuring the structure 234 on the inner wall of the front surface 232. That is, the reinforcement panel 234 may be configured inside the backpack 200 in such a way that it is generally configured with an inner side of the front wall 232 of the backpack 200 to provide support thereto. The reinforcement structure 234 may be sewn into the inner or outer lining of the backpack 200, may be riveted onto the back or front of the front wall 232 of the backpack, or may be configured with the backpack 200 and/or the front wall 232 of the backpack 200 using any adequate configuration and/or attachment methods or mechanisms. Note that the reinforcement panel 234 may also be configured on the outside surface of the backpack 200, in an intermediary layer of the backpack 200 (e.g. in the lining), or in any other configuration with regards to the backpack 200 such that the structure 234 may provide the required reinforcement. In any event, it may be preferable that the reinforcement structure 234 be configured with the backpack 200 such that it remains in place during usage of the backpack 200 while providing adequate support to the front wall 232 (or any wall as configured) and the attachable panel 238 as required.

It may be preferable that the reinforcement panel 234 have a general width and height that may generally correspond to the surface that it may be reinforcing (e.g. the front surface 232). However, note that the reinforcement panel 234 may also extend across different sections or sides simultaneously (e.g. the front side, the left side, the right side, the back side, the bottom side, the top side, or any other sides or combinations of sides) to provide support to areas of the backpack 200 that may or may not be configured with an attachable panel 238. The reinforcement structure 234 may extend continuously across the sections and sides or may be in segments as required.

The attachment mechanisms 204a may be configured and/or generally incorporated into and with the reinforcement structure 234 such that the reinforcement structure 234 may provide support to the attachment mechanisms 204a as well. This may allow the attachment mechanisms 204a to more easily engage and attach to the attachment mechanisms 204b that may be configured with the attachable panel 238. This is depicted in FIG. 18A where the attachment mechanisms 240a are depicted as overlapping the reinforcement structure 234. In one example, the attachment mechanisms 240a may be directly attached to the reinforcement structure 234 such that the reinforcement structure 234 may act as a base or support for the attachment mechanisms 240a. The attachment mechanisms 204a may be configured with both the reinforcement structure 234 and the front wall 232 of the backpack 200, only with the reinforcement structure 234, or in any combination thereof. However, this may not be necessary. Note also that the attachment mechanisms 240a may not necessarily be configured with the reinforcement structure 234, may not necessarily overlap the reinforcement structure 234 as shown in the figure, and may be configured with the backpack 200 in any other locations and positions. In addition, some attachment mechanisms 240a may be configured in combination with the reinforcement structure 234 while other attachment mechanisms 240a may not. Any combination thereof is also within the scope of this embodiment.

In addition, multiple reinforcement panels 234 may be required to adequately support the backpack 200 so that it may not droop or otherwise become misshaped, especially in the area where it may be configured with the detachable panel 238. For example, in addition to the reinforcement panel 234 depicted in FIG. 18A generally configured with the front wall 232 of the backpack 200, additional reinforcement panels 234 may also be configured with the left and right sides of the backpack 200 to provide additional upright support to the backpack 200. It can be seen that any number of reinforcement panels 234 may be configured with the backpack 200 as necessary to perform its functions.

It should also be noted that while FIG. 18A may depict the reinforcement structure 234 as a single piece, the reinforcement structure may be multiple pieces, elements, components or structures. For example, the reinforcement structure 234 may comprise a stiff or semi-stiff strip or post that may be generally configured across the top of the front wall 232 of the backpack. In this example, the reinforcement structure 234 may be generally located towards the top portion of the front wall 232 of the backpack 200. In another example, the reinforcement structure 234 may comprise vertical strips or posts that may be configured across the front wall 232 of the backpack 200. In another example, the reinforcement structure 234 may be a frame, a cross or an “X” shaped reinforcement structure 234. It can be seen that the reinforcement structure 234 may comprise any combination of such example structures and forms as well as any other type of structures and/or materials and that the scope of the reinforcement structure 234 is not limited by the examples described herein.

The reinforcement structure 234 may also be configured with the attachable panel 238. For example, the reinforcement structure 234 may include a reinforcement panel 238 that may be attached or otherwise configured directly with the attachable panel 238 such that the reinforcement panel 234 may provide structural support to the panel 238. The reinforcement panel 234 may be formed as a thin panel that may have a similar shape and size as the attachment panel 238 such that the reinforcement panel 234 may be stitched together (or attached using other types of attachment methods such as adhesive, etc.) with the attachment panel 238. In this way, when the attachable panel 238 may be configured with a side of the backpack 200, the reinforcement panel 234 may provide support to the combined attachable panel 238 and side of the backpack 200. The reinforcement structure 234 may also be formed as any type of structure (posts, strips, frames, crosses, etc.), shape or form as described above in relation to the reinforcement structure 234 and its configuration with the backpack 200 such that all of the descriptions described above directly apply to how the reinforcement structure 234 may be shaped, sized and generally configured with the attachable panel 238 as well.

The attachment mechanisms 240b may be configured with the reinforcement structure 238 in addition to the attachable panel 238, with the reinforcement structure 234 and not the attachment panel 238, or in any combination thereof. In this way, the attachment panel 234 may or may not provide support to the attachment mechanisms 240b.

In addition, the attachable panel 238 may be double-sided. That is, it may include graphics, art or other types of imagery on both its front and back sides. In this way, the attachable panel 238 may be detached, turned over and reattached to display a different image on the backpack 200. In this scenario, it may be necessary for the detachable panel 238 to include attachment mechanisms 240b on both its front and back sides that may be aligned and engaged with the attachment mechanisms 240a (on the backpack 200) when the attachable panel 238 may be configured with the backpack 200. For example, if the attachment mechanisms 240a, 240b may be snaps, it may be preferable that the attachment panel 238 may include the appropriate snap component (male or female) on each of its front and back sides so that the attachment mechanisms 240b may align and engage with the corresponding attachment mechanisms 240a on the backpack when the panel 238 is attached to the surface 232 of the backpack 200. In another example, if the attachment mechanisms 240a, 240b may be hook and loop materials, it may be preferable that both sides of the attachable panel 238 may include the appropriate material (hook or loop) that may properly engage the type of hook and loop material that may comprise the attachment mechanism 240a on the backpack 200.

However, including individual attachment mechanisms 240b on both the front and back sides of the attachable panel 238 may be labor intensive and bulky. Therefore, it may be preferable that a single double-sided attachment mechanism may be attached at each location on the attachable panel 238 instead of two single-sided attachment mechanisms 240b (one on the front side and one on the opposite back side of the attachable panel 238).

An example of a double-sided attachment mechanism 240c is depicted in FIG. 18B. The double-sided attachment mechanism 240c may include a disk 242 with an opening 244 (preferable in or near the center of the disk 242) and radially outward slits 246. The radially outward slits 246 may run from the inner opening 244 to a position between the inner opening and the outer edge of the disk 242. The slits may pass through the disk 242 such that the family of slits 246 may generally form a family of flexible fingers 248. While seven slits 246 and seven fingers 248 are depicted in FIG. 18B, any number of slits 246 and fingers 248 may be used.

The disk 242 may be formed of a plastic such as ABS or Polycarbonate (or other types of materials) that may be flexible such that the fingers 248 may be able to flex up and down in relation to an axis that may pass through the inner opening 244 perpendicular to the disk 242.

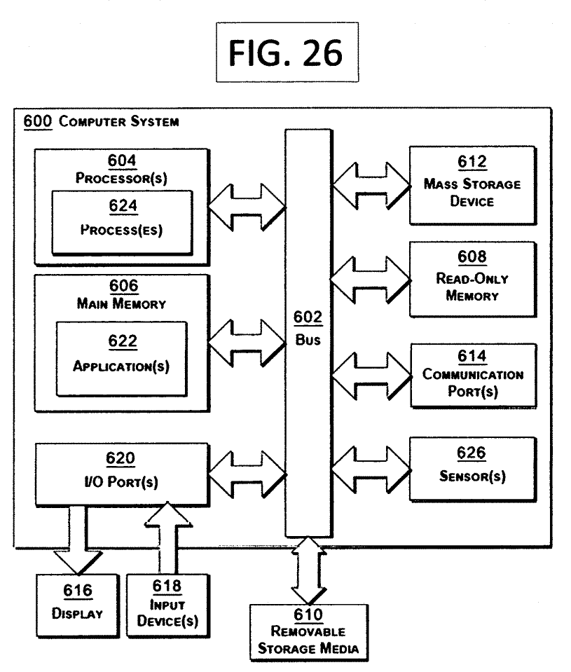

As shown in FIG. 26, the double-sided attachment mechanism 240c may engage with an attachment mechanism 240a that may be a post with a top tip, a wider middle section and a narrower bottom section. This attachment mechanism 240a may be the attachment mechanism 240a configured with backpack 200 in FIG. 18A. This may be similar to the male component of a snap. The inner opening 244 of the double-sided attachment mechanism 240c may be aligned with the top tip of the male attachment mechanism 240a such that the top tip of the post 240a may enter into the inner opening 244. However, it may be preferable that the width of the wider middle section of the post 240a may be wider than the diameter of the inner opening 244 such that the fingers 248 must flex upwards as the disk 242 is pushed downward further onto the post 240a. By flexing upward, the fingers 248 may allow the inner opening 244 to pass over the wider middle section of the post 240a, and when the inner opening 244 reaches the lower narrower section of the post 240a, the fingers 242 may return to their un-flexed states and the disk 242 may generally be secured around the bottom section of the post 240a as shown in FIG. 18C.

It may be preferable that when the inner opening 244 is secured around the lower portion of the post 240a as shown, that the width of the section of the post 240a that may be configured with the inner opening 244 of the disk 242 may be similar to the diameter of the inner opening 244. In this way, the fingers 248 may be generally un-flexed and the post 240a may be held snug in the inner opening 244. It may be preferable that there be no or minimal lateral movement of the post 240a in this configuration such that the attachment mechanisms 240a and 240a may be secured together snug and tight.

It can be seen that because the attachment mechanism 240c may be symmetrical with respect to its top surface and its bottom surface, that a post 240a may be inserted into the inner opening 244 and configured with the attachment mechanism 240c from either direction (into and through the inner opening 244 from the top or from the bottom). In this way, the double-sided attachment mechanism 240c may be configured with the double-side attachable panel 238 (as depicted in FIG. 18A) such that either side of the double-sided attachment panel 238 may be configured with the attachment mechanisms 240a on the backpack 200. That is, because the attachment post 240a may be pressed through the inner opening 244 of the double-sided attachment mechanism 240c from the front or the back, the front and back surfaces of the attachable panel 238 may be configured with the attachment mechanisms 240a on the backpack 200. It should be noted that the attachable panel 238 need not necessarily be double-sided and yet may still utilize the double-sided attachment mechanism 240c. The double-sided attachment mechanisms 240c may be secured to the attachable panel 238 through the use of grommets, rivets, stitches, glue, adhesive, staples and clamps or by other methods of attachment. The double-sided attachment mechanism 240c may also be configured with the reinforcement structure 234 in any configuration as described above in relation to attachment mechanisms 240a and 240b.

It should be clear that the double-sided attachment mechanism 240c may be used with any of the embodiments and/or examples of any and all of the bags and attachable panels that are described in this specification. It should also be clear that any of the attachable panels in any of the examples and/or embodiments described in this specification may be single-sided or double-sided.

Another type of carrying bag that may be configured to include an attachable panel may be a type of bag often referred to as a messenger bag 300 or a computer bag as depicted in FIG. 19. As shown, messenger bag 300 may have similar characteristics and elements as backpack 200 described in earlier sections. Specifically, as shown in FIG. 19, messenger bag 300 may have a body 302, a front side 304, a top opening 306, an attachable panel 308 that may be interchangeable, and other components. In addition, messenger bag 300 may also have a shoulder strap 316 to carry messenger bag 300 over the shoulders hands free.

It will be obvious to one skilled in the art that messenger bag 300 resembles guitar bag 10 and backpack 200 with regards to the current invention such that the descriptions above for how the current invention may be incorporated with guitar bag 10 and backpack 200 are directly applicable to how the current invention may be incorporated with messenger bag 300. It will also be obvious to one skilled in the art that all of the details, descriptions, variations and different configurations described in earlier sections of this specification in regards to guitar carrying case 10 and backpack 200 in relation to the current invention and how an attachable panel may be configured with guitar carrying bag 10 and backpack 200 also directly apply to messenger bag 300 such that these details, descriptions, variations and configurations need not be repeated here.

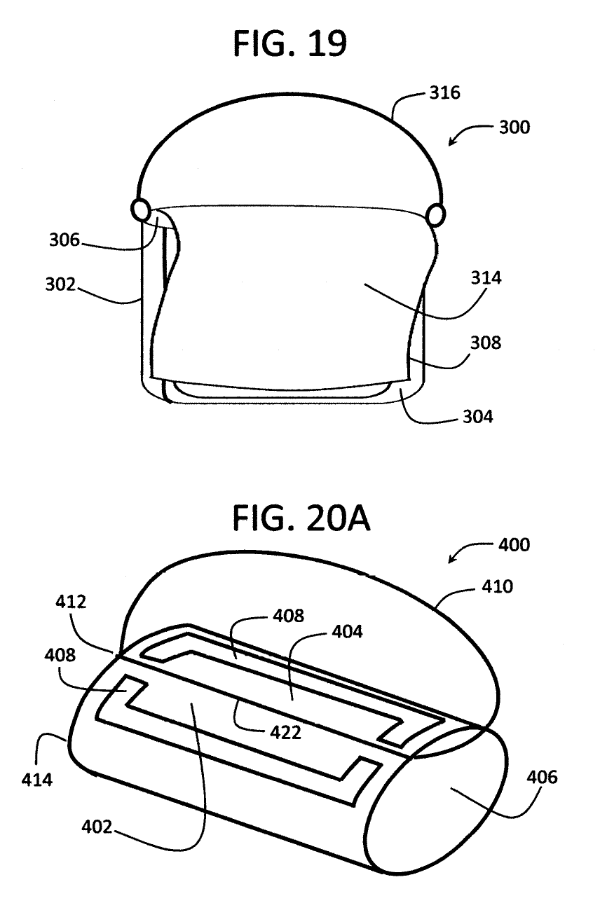

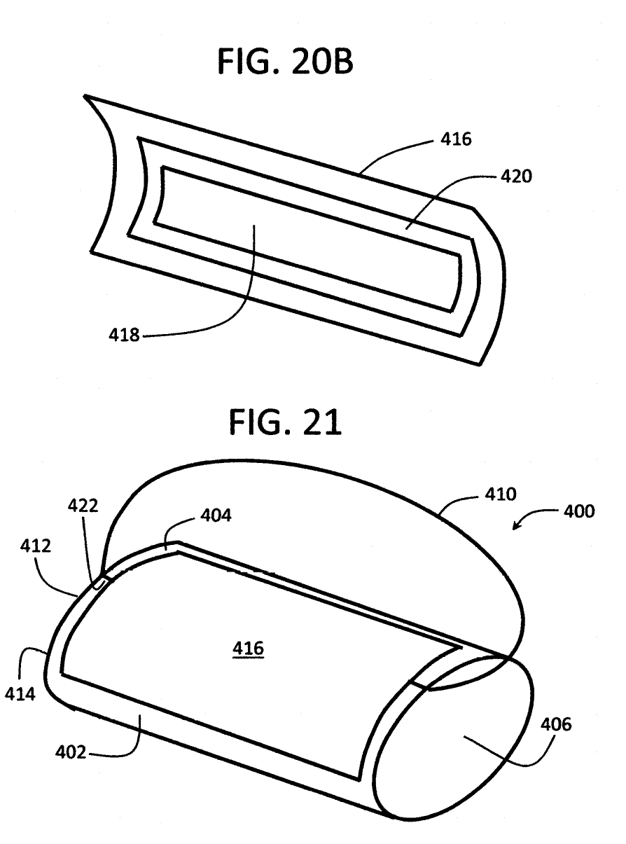

Another type of carrying bag that may be configured to include an attachable/detachable panel may be a duffle bag, often also referred to as a sports bag or an overnight bag. As shown in FIG. 20A, the duffle bag 400 may include body 412, left side 402, right side 404, zippered top opening 422, front side 406, rear side 414, hook and loop section 408, attachable panel 416 that may be interchangeable and shoulder strap 410. Similar to descriptions in previous sections in regards to guitar carrying bag 10 with hook and loop section 50 on front side 20 in FIG. 1 that may be configured to mate with hook and loop section 120 on the back side 110 of attachable panel 100 of FIG. 2, hook and loop section 408 on duffle bag 400 may be generally configured on left side 402 and right side 404 of FIG. 20A to mate with hook and loop section 420 on the back side 418 of attachable panel 416 of FIG. 20B. With hook and loop section 420 on the back side 418 mated with hook and loop section 408 on the upper sides 402, 404 of duffle bag 400, duffle bag 400 of FIG. 21 may result. In the depiction of FIG. 21, attachable panel 416 may be generally attached to the sides and top of duffle bag 400 such that graphical artwork (not shown) may be printed or otherwise affixed to the sides and top side of attachable panel 416 to change the graphical design of duffle bag 400.

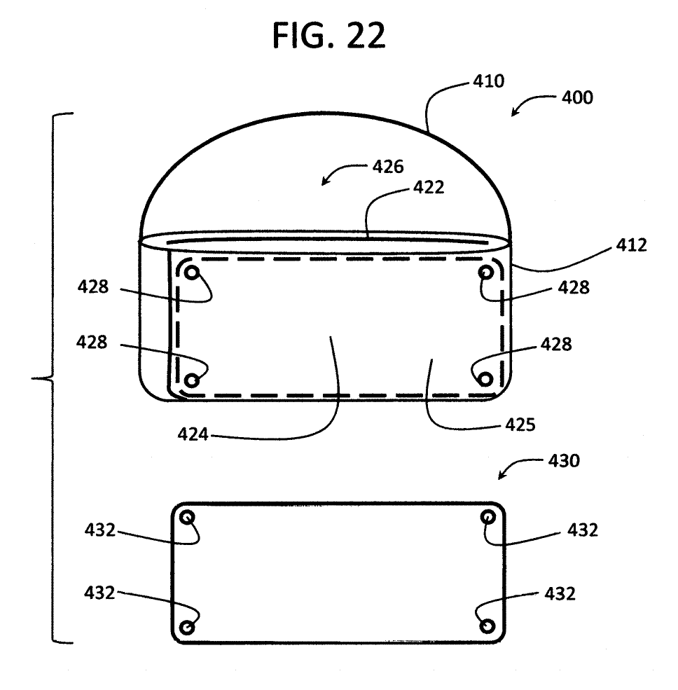

In the example shown in FIG. 21, attachable panel 416 may generally cover zippered top opening 422; however, attachable panel 416 may include an opening (not shown) that may allow access to zippered top opening. In addition, detachable panel 416 may include divided attachable panels 416 or multiple attachable panels 416 such that one attachable panel 416 may be attached to left side 402 and a second attachable panel may be attached to right side 404. For example, FIG. 22 depicts a duffle bag 400 that may include body 412, front side 424 (that may correspond to the left side 402 of bag 400 in FIG. 20A), back side 426 (that may correspond to the right side 404 of bag 400 in FIG. 20A), reinforcement structure 425 (that may correspond to reinforcement structure 234 in FIG. 18A), zippered top opening 422, attachment mechanisms 428 (that may coincide with attachment mechanisms 240a in FIG. 18A) a shoulder strap 410 and other components.

Attachable panel 430 (that may correspond to the attachable panel 238 in FIG. 18A) may include attachment mechanisms 432 (that may correspond to attachment mechanisms 240b and/or double-sided attachment mechanisms 240c in FIG. 18A). Note that the attachable panel 430 may be configured to the duffle bag 400 using any and all configurations described in relation to how the attachable panel 238 may be configured with the backpack 200 as described above in relation to FIGS. 18A-18C as well as the embodiment discussed in relation to FIGS. 6-17. This may include all of the details of how the attachable panel 430 (that corresponds to the attachment panel 238) may be configured with the attachment mechanisms 428, 432 (that correspond to attachment mechanisms 240a, 240b and 240c). In addition, the attachable panel 430 may be single-sided, double-sided or any combination thereof.

Note that any number of attachable panels 416 may be attached to any number of sides of the duffle bag 400 that may or may not cover up zippered top opening 422. For example, the attachable panels 416 may be configured with the front 424, the back 426 or with any other surface of the duffle bag 400.

Also, while top opening 422 has been described as utilizing a zipper as an attachment mechanism to secure top opening 422 closed, other attachment mechanisms such as VELCRO, snaps, buckles and other attachment means may be used instead. Also, top opening may not utilize any attachment means and attachable panel 416 may or may not assist in holding top opening closed such that the contents within duffle bag 400 may be secure. In this way, the attachable panel 416 may act as the closing mechanism for the top opening of the duffle bag 400.

It will be obvious to one skilled in the art that duffle bag 400 resembles guitar bag 10 and backpack 200 with regards to the current invention such that the descriptions above for how the current invention may be incorporated with guitar bag 10 and backpack 200 are directly applicable to how the current invention may be incorporated with duffle bag 400. It will also be obvious to one skilled in the art that all of the details, descriptions, variations and different configurations described in earlier sections of this specification in regards to guitar carrying case 10 and backpack 200 in relation to the current invention and how an attachable panel may be configured with guitar carrying bag 10 and backpack 200 also directly apply to duffle bag 400 such that these details, descriptions, variations and configurations need not be repeated here.

Reinforcement structure 425 (depicted as dashed lines in FIG. 22) may correspond to the reinforcement structure 234 with regards to backpack 200 in FIG. 18A, and all of the details, descriptions, variations, examples and configurations regarding the reinforcement structure 234 and its configuration with the backpack 200 and/or the attachable panel 238 directly apply to this example of the duffle bag 400 with reference to FIG. 22, and need not be repeated here.

In addition to guitar carrying cases and bags 10, backpacks 200 and computer bags 300 and duffle bags 400, there are many additional types of carrying bags and cases that may be configured to include attachable panels and therefore be covered by the current invention. The other types of carrying bags or cases may include but are not limited to purses, luggage, business cases, tablet computer cases and sleeves, smartphone cases, laptop computer cases, artwork carrying cases, and other types of carrying bags and cases that may have similar or different shapes compared to the guitar case 10, backpack 200 and duffle bag 300 described above. These bags and cases may be designed to carry other types of items compared to a musical instrument case 10, a backpack 200, a messenger bag 300 or a duffle bag 400, but may include similar elements as the above described guitar bag 10, backpack 200, messenger bag 300 and duffle bag 400 such as front sides, top sides, side sides, attachment mechanisms to attach attachable panels, top openings and other elements such that they too may be configured to include an attachable panel. It will therefore be apparent to one skilled in the art that the entire description above of configuring a guitar case or bag 10, a backpack 200, a messenger bag 300 and a duffle bag 400 with an attachable panel or multiple attachable panels may directly apply to these other types of carrying cases and bags as well. In addition, these other types of carrying bags and cases may operate in a similar manner with regards to the attachable panel or multiple attachable panels in comparison to the above described guitar carrying bag 10, backpack 200, computer bag 300 and sports bag 400 with regards to the attachable panels, for example but not limited to, how to attach an attachable panel to the carrying bag or case, how to remove an attachable panel from the carrying bag or case, how to retrofit an existing carrying bag or case to receive an attachable panel, and other characteristics.

In addition, it will be obvious to one skilled in the art that all of the descriptions, details, variations and different configurations described in earlier sections of this specification in regards to guitar carrying case 10, backpack 200, messenger bag 300 and duffle bag 400 in relation to the current invention and how an attachable panel may be configured with guitar carrying bag 10, backpack 200, messenger bag 300 and duffle bag 400 also directly apply to the additional types of carrying bags and cases such that these descriptions, details, variations and configurations need not be repeated here.

In another embodiment, it may be desirable to provide a means to attach the attachable panel 100 to a carrying bag that may not have been designed and manufactured specifically to receive the attachable panel 100. In one example of this scenario, a user may already own a guitar carrying bag that may not have hook and loop section 50 attached to its front panel 20. In this case, the means to attach an attachable panel 100 may be provided to the user so that the user may retrofit their existing bag to have the ability to receive attachable panel 100. This may include providing the user with hook and loop fastening material or other fastening mechanisms that may be affixed to the front panel of their existing instrument bag that may be aligned and mated with hook and loop section 120 on attachable panel 100.

In one embodiment, loop fastening material or hook fastening material may be provided to the user in strips, patches, or other patterns that may be attached to their existing guitar bags. The provided hook and loop sections may be adhesive backed such that the adhesive backing on the provided hook and loop sections may be used to affix the hook and loop sections to the users existing bag. The provided hook and loop sections may also have heat-activated adhesive means on the back of the sections such that the hook and loop may be attached to the existing instrument bag using a heating device such as an iron or other means. Other means such as glue, pins, clips, latches, sewing means, magnets or other means may also be provide to the user to affix the provided hook and loop sections to their existing instrument bags. It may be preferable that the fastening means may come with instructions that may guide the user to properly attach the provided fastening means to their existing instrument bag in such a way that the sections may be fixedly attached in the proper locations such that at least some of the fastening means may align with and mate up with corresponding fastening means, if any, on the attachable panel 100. In this way the attachable panel 100 may be removably attached to the user's existing instrument bag as described above.

It may also be preferable that the attachable panel 100 that the user may intend to attach to their retrofitted instrument bag may have a generally similar shape and size of the panel of the existing instrument bag that the user intends to attach it to. To these ends, the manufacturer may provide a number of differently shaped attachable panels 100 that may generally fit a significant number of existing instrument bags that may have been sold prior or are currently on the market. The user may then choose the attachable panel 100 that may most closely resemble the size and shape of the panel on their existing instrument bag that they wish to attach the attachable panel 100 to.

Also, it may not be necessary that the attachable panel 100 generally resemble the size and shape of the existing bag being retrofitted to receive attachable panel 100. In one example of this type, attachable panel 100 may only attach to a portion of a panel on the existing bag. In this case, attachable panel 100 may cover only a portion of the panel, for example the front face of the existing bag, and may therefore be any shape. In this embodiment it may be preferable that attachable panel 100 may fit generally within the entire or a portion of the outer contour of the face on the existing bag that it is to be attached to but this may not be required. It may also be preferable that attachable panel 100 not extend past the outer circumference of the face on the existing back to which it is to be attached to, but this also may not be required. In addition, attachable panel 100 may be modified to fit within the contour of the panel to which it may be attached to by folding, cutting or other modification techniques.

While the fastening means that may be provided to the user to attach to their existing instrument bag described above include hook and loop fastening means, other means may be used to attach the attachable panel 100 to the user's existing instrument bag such as pins, snaps, clips, latches, zippers or other means. For instance, when attaching attachable panel 100 to an instrument bag that may not have hook and loop sections 50, attachment mechanisms other than hook and loop fastening mechanisms may be utilized. In this application, other means such as clips, pins, snaps, latches or zippers may be provided to attach attachable panel 100 to the existing instrument bag. These alternative fastening means may be attached to the existing instrument bag, to the attachable panel 100, or to both the existing instrument bag and attachable panel 100 such that attachable panel 100 may be attached to and removed from the existing instrument bag in order to replace attachable panel 100 with another panel of different graphical design. These fastening means may remain on the existing gig bag to receive other attachable panels 100, may remain on attachable panel 100, may remain on both the existing gig bag and the attachable panel, or may be removed from the existing gig bag and attachable panel 100 when the panels 100 are exchanged.

It should be noted that if the attachable panel 100 may not adequately resemble the shape and size of the panel of the existing gig bag that the user may be retrofitting to receive and attach to attachable panel 100, means to adjust the size and shape of attachable panel 100 may be provided to the user. These means may include the ability to alter the shape and size of attachable panel 100 by folding, cutting or other means that may alter the shape and size of attachable panel 100.

While the example described above of retrofitting an existing carrying bag that was not originally designed to receive an attachable panel used an instrument carrying bag, specifically a guitar carrying bag, as the example to describe the various elements of the current invention associated with this concept, the elements of the current invention may also pertain to any other type of carrying bag that may be retrofitted to receive an attachable panel. Examples of other types of carrying bags that may be retrofitted to receive an attachable panel may include backpacks, laptop cases, messenger bags, purses, travel bags, business bags, sports bags, duffle bags, luggage and other types of carrying bags and cases.

As stated earlier, graphical artwork may be printed on or otherwise affixed to the front panel 130 of attachable panel 100 using a printing machine, a dye sublimation system, silk screening techniques, paint, decals, stickers or other means. In one embodiment, the manufacturer of the instrument bag 1 0 and attachable panels 100 may offer artwork designs, pictures and other types of graphical files that may be chosen by the user to be printed on front side 130 of attachable panel 100. In this embodiment, the attachable panel 100 with the design from the manufacturer affixed to its front side 130 may be available for sale in a retail store, in an online store, through an app or in other places. It should be noted that a variety of attachable panels 100 with a variety of different graphical artwork designs printed or otherwise affixed to their respective front sides 130 may be available by the manufacturer for purchase. It should also be noted that the user may have the ability to purchase an attachable panel 100 with a particular design by itself or with the carrying bag 10 that the attachable panel 100 may be attached to.

In another embodiment, the manufacturer may provide tools for the user to create their own graphical artwork to have printed or otherwise affixed to the attachable panels 100. In one embodiment of this type, the manufacturer may provide a website, an app, software or other types of tools that may allow the user to choose different graphical patterns or images, and may provide the ability for the user to position, size, crop and otherwise manipulate or modify these patterns or images within a template that may resemble the shape of attachable panel 100. The user may then submit the artwork to be printed or otherwise affixed onto an attachable panel 100 to the manufacturer who may print or otherwise affix the artwork to attachable panel 100 and send it to the customer. In addition, the user may perform the above functions without the use of a template that may resemble the shape of attachable panel 100.

In another embodiment of this type, the manufacturer may provide the user with graphical design software that may reside on their website or elsewhere on the Internet, may be provided through the use of a memory device such as a CD, DVD, flash memory device, hard drive memory device or through other means that the user may use to create their own artwork to have printed or otherwise affixed to an attachable panel 100. The manufacturer may also provide the customer with an app or other types of software tools that the user may use to create their own artwork to have printed onto attachable panel 100. The manufacturer may also provide a combination of these different types of tools and functionalities, as well as other types of tools and functionalities to the user that may assist the user to create artwork or pictures that may be printed onto an attachable panel 100.

In another embodiment, the manufacturer of the instrument bag 10 and attachable panels 100 may allow the user to provide their own graphical artwork, pictures, logos, or other media files to the manufacturer to be printed or otherwise affixed to the attachable panel 100. In this scenario, the manufacturer may provide a means for the user to provide to the manufacturer the files to print onto attachable panel 100. Such means may include the ability to upload the graphical artwork files through a website, or while using an app on a mobile device such as a smartphone or tablet computer, or by sending the files by email to the manufacturer, or by other means such that the manufacturer may receive the files and may print or otherwise affix the artwork to the attachable panel 100. The manufacturer may also provide an online template, a template computer file, a physical template or other type of template that may resemble the shape of the attachable panel 100 to the user such that the user may overlay their artwork or picture onto the template in order to position, size, crop and otherwise design and edit their artwork to be printed or otherwise affixed to the attachable panel 100. Other means that may be used to allow the user to provide their own artwork to the manufacturer may include FTP, Cloud computing file storage means, files sent to the manufacturer on physical media storage devices such as flash drives or DVDs, or other means.

In addition, means for a person or customer to upload or otherwise provide the manufacturer of carrying bag 10, 200, 300, 400 with graphical artwork to print or otherwise affix to attachable panel 100, 208a/b/c, 238, 308, 416, 430 may be provided to the customer at a retail point of purchase (POP) kiosk or installation of carrying case 10, 200, 300, 400 and/or attachable panel 100, 208a/b/c, 238, 308, 416, 430 (e.g. within a retail store or other vendor). In this scenario, the retail store may provide a POP interactive display that may include an input device that may allow the customer to upload or otherwise provide the graphical artwork or pictures to the manufacturer to print onto attachable panels 100, 208a/b/c, 238, 308, 416, 430. The customer may be able to transfer their artwork, images or pictures from their smartphone, tablet computer, memory device or other type of device to the interactive display such that the interactive display may then provide the artwork or pictures to the manufacturer of attachable panels 100, 208a/b/c, 238, 308, 416, 430. Such interactive display may include a tablet computer or other type of input device as well as software, apps or other applications.

The manufacturer may then print or otherwise transfer the artwork or image files to for the customer and ship or otherwise provide the attachable panel(s) 100, 208a/b/c, 238, 308, 416, 430 directly to the customer, ship or otherwise provide the attachable panel(s) 100, 208a/b/c, 238, 308, 416, 430 to the retail point of purchase for the customer to pick up, or otherwise provide them to the customer by other means. In this scenario, the customer may have the ability to purchase the carrying bag(s) 10, 200, 300, 400 and the attachable panels 100, 208a/b/c, 238, 308, 416, 430 from the retail store and may leave the store with the carrying bag(s) 10, 200, 300, 400 with or without an attachable panel 100, 208a/b/c, 238, 308, 416, 430, in which case the customer may be provided with the attachable panel 100, 208a/b/c, 238, 308, 416, 430 at a later time as described above.

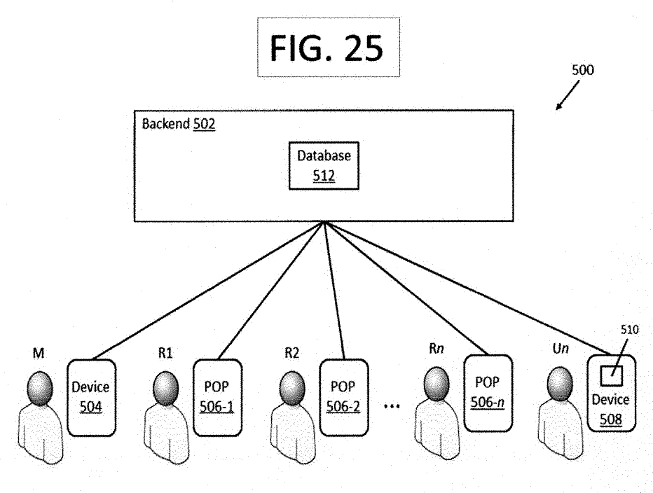

It can be seen that for this to be accomplished, the manufacturer may preferably have a system 500 and method that may communicate with the retailer and/or the customer in order to acquire the uploaded images, the shopping cart information (e.g. ordered products), order information, the shipping information (e.g. customer contact and shipping information), retail store information, as well as other information. This is depicted in FIG. 25. In addition, the system 500 may include the ability to provide financial transactions between the retailer and the manufacturer. For example, the retailer may receive payment onsite for the products from the customer, and may then pay at least a portion of the proceeds to the manufacturer (e.g. the wholesale price) through the system 500. In addition, the manufacturer may need to transfer money to the retailer for returns, marketing and other types of costs, fees or transactions and these payments may also be enabled by the system 500.

The system may include a backend 502 (e.g. a cloud platform) that the manufacturer(s) M (one or more) and one or more retailer(s) Rn with POP systems 506-1, 506-2 . . . 506-n (collectively and individually POP(s) 506) may each communicate with. In this way the backend 502 may implement and execute the data transfers between the retailer(s) Rn and the manufacturer(s) M as necessary throughout the marketing and sales cycles of the products 100, 208a/b/c, 238, 308, 416, 430. Note that one or more retailers Rn may include one or more customers each that may be interacting simultaneously with one or more POPs 506 in real time.

The cloud platform 502 may include one or more servers (such as Internet servers, LAN servers, WAN servers or other types of servers) and may include all of the components (hardware and software) necessary to transmit data to and receive data from the manufacturer M and the retailer(s) Rn (e.g. the images to be printed, the shopping cart information, the customer information, etc.). For example, the cloud platform 502 may include a CPU, microprocessor, microcontroller, chipset, control board, RAM, general memory, network boards, power supplies, an operating system, software, applications, scripts and any other component, application, mechanism, device or software as required. The cloud platform 502 may also include at least one database 512, software system(s), software platform(s), etc.

The cloud platform 502 may communicate with the retailer POPs 206 through an Internet connection (e.g., via a modem through a service provider) that may include a wireless connection such as Wi-Fi via an Internet modem and router, through a different type of network (such as LAN, WAN, etc.), via network cables or via telephony, transmission lines or by other communication methods.

In one example, the purchase process may be as follows:

The customer may visit a retailer R that may present bags 10, 200, 300, 400 and corresponding attachable panels 100, 208a/b/c, 238, 308, 416, 430 for sale. The retailer R may also provide an interactive POP 506 that the customer may use to upload their images to the backend 502. Note that the retailer may also offer pre-printed attachable panels 100, 208a/b/c, 238, 308, 416, 430 for sale as well as made-to-order attachable panels 100, 208a/b/c, 238, 308, 416, 430 via their POP system 506.

The POP 506 may allow the user U to transfer his/her image(s) to the system 500 via email, text, USB flash drive, or by other transfer methods. Note that is the customer may not have their images available at the time of the purchase, the customer may be provided an email address, a text address, a website URL, an FTP link or any other type of mechanism that may allow the customer to upload their images at a later time (e.g. from their home computer). In this scenario, the images may be uploaded to the retailer (via the system 500) who may then provide them to the manufacturer (via the system 5000, or directly to the manufacturer (via the system 500).

Once the POP 506 may acquire the images, the POP 506 may allow the customer to position the images on a virtual print template of the attachable panels 100, 208a/b/c, 238, 308, 416, 430 using the screen (preferably touchscreen) of the POP 506. This may allow the customers to position their images onto the attachable panel print templates so that they may be printed onto the attachable panels 100, 208a/b/c, 238, 308, 416, 430 as desired. This may involve positioning, rotating, orientating, cropping, adding text, adding backgrounds, and other types of editing of the images on the product print templates.

Once the images are positioned onto the templates, the user may then purchase the attachable panel(s) 100, 208a/b/c, 238, 308, 416, 430 and/or an accompanying bag 10, 200, 300, 400 from the cashier (or from a self-service station or by other payment methods). Note that the customer may purchase the customized attachable panel(s) 100, 208a/b/c, 238, 308, 416, 430 that they may have uploaded through the POP 506, as well as additional pre-printed attachable panels 100, 208a/b/c, 238, 308, 416, 430 as well. The user may also purchase bags 10, 200, 300, 400 as desired.

Once the user has purchased the product(s), the retailer R may confirm the sale to the manufacturer M via the system 500 and may communicate the templates/Images, shipping information, contact information, shopping cart information, and other pertinent information to the manufacturer M so that the manufacturer M may process and fulfill the order. This may involve the templates/images and other data and information being uploaded to the backend 502, stored in the database 512 and downloaded by the manufacturer M. Note that the manufacturer may utilize a computer 504 or other type of electronic device that may download the images and data from the backend 502.

Note that the customer U may input their shipping address and other pertinent contact information to the POPs 506, at the cashier, or at a different location.

The customer U may then leave the retail location with their purchases (e.g. a bag 10, 200, 300, 400 with or without a pre-printed attachable panel(s) 100, 208a/b/c, 238, 308, 416, 430) so that they do not go home empty handed, but instead have the instant gratification of leaving with a physical product. If their images were not available at the time of purchase, the customer may then go to another location (e.g. their home with their home computer) to perform the upload via the system 500 (via email, a link provided to the customer, text or other communication mechanisms). In this case, the manufacturer M may have already been notified of the sale by the retail store such that when the manufacturer M receives the images it may directly proceed to product and fulfill the order.

The manufacturer M may then produce the purchased attachable panel(s) 100, 208a/b/c, 238, 308, 416, 430 and provide them directly to the customer, to the retailer so that the customer can pick them up or have them otherwise delivered to them by the retailer, to a product locker, or to another location as desired.

It should be appreciated that the sequence of acts described above with relation to the purchase process of the attachable panel(s) 100, 208a/b/c, 238, 308, 416, 430) and other products is meant for demonstration purposes, and the acts described may be performed in different orders. In addition, some of the acts described may not be performed and other acts not described may be performed. The examples described above in no way limit the scope of the system 500.

The system 500 may include a mobile application 510 (“app”) (denoted as a block 510 on the display of the user's device 508) that the customer may download or otherwise load onto his/her own mobile device 508 (e.g. smartphone, tablet computer, etc.). The app 510 may provide an interface with the system 500 and the backend 502 to allow the customer(s) to transfer their artwork, graphics, images or picture files from their own mobile device or other device to the retailer or manufacturer M of attachable panels 100, 208a/b/c, 238, 308, 416, 430. The app 510 may perform all or some of the functionalities of the POP 506 and may in this way replace the POP 506. The customer may download the app from a website (e.g. the manufacturer's website, the retail store's website, an app store, etc.) or acquire the app from another source in order to use the app to transfer the artwork or image files to the retailer or the manufacturer of attachable panels 100, 208a/b/c, 238, 308, 416, 430.

The customer Un may preferably use the app 510 while they may be shopping within a particular retailer that provides attachable panels 100, 208a/b/c, 238, 308, 416, 430 and/or bags 10, 200, 300, 400 for sale. In this way, the user Un may use the app to upload their images to the manufacturer M and purchase the bag 10, 200, 300, 400 and/or pre-printed attachable panels 100, 208a/b/c, 238, 308, 416, 430 at the retailer cashier (or through the app) to take the products home with them. The app 510 may include or utilize a geographic locator such as GPS (native on their device 508 for example) that may identify the retail store R that the customer may be physically located. Alternatively, the user U may input into or otherwise choose the location from a list of possible retail locations on the app 510. In any event, the app 510 may determine the retail store R where the customer may be located such that the financial transaction (purchase) may be executed and confirmed with the manufacturer M and the customer may leave the store with the bags 10, 200, 300, 400 and/or pre-printed attachable panels 100, 208a/b/c, 238, 308, 416, 430.

Note that the app 510 may generally perform all of or some of the functionalities of the POPs 506 during use, may interface with the system 500 and the backend 502, and in doing do, may interface with both the retailer(s) Rn and the manufacturer(s) M. In this way, the app 510 may enable the entire purchase flow as described above in relation to the use of the POP 506. Note that while FIG. 25 shows one user Un with device 508 and app 510 interacting with the system 500 and the backend 502, any number of users Un with any number of devices 508 each with app 510 may be interacting with the system 500 and the backend 502 simultaneously and in real time.

The system 500 may also keep track of the specific store and sales information (name of store, location of store, items ordered, total sale value, and other information) such that the store may get credit for the sale of the customized attachable panel(s) 100, 208a/b/c, 238, 308, 416, 430. This information may be useful to the manufacturer of attachable panels 100, 208a/b/c, 238, 308, 416, 430 in order to know the sales performance of the various stores that may be providing this service. This information may also be used to provide payments or incentives to the stores that make the sales for the manufacturer.

In addition, it may be preferable for the manufacturer M to use the contact information of the acquired customers to market additional products to the customers, provide them with coupons and/or purchase incentives, newsletters, etc. However, it may be preferable for the customers to opt-in with the manufacturer to receive this additional content.

It will also be understood and appreciated by a person of ordinary skill in the art upon reading this specification that the system 500 may be used with any type of product that may include a first component that may be purchased or otherwise acquired at a retail store or other location and a customizable second component that may be produced and then configured with the first component. In the examples above, the first component may be a bag 10, 200, 300, 400 and the customizable second component may be an attachable panel(s) 100, 208a/b/c, 238, 308, 416, 430. However, the first component may not necessarily be a bag 10, 200, 300, 400 but instead may be any other type of product that may allow a customizable second component to be configured with it after the customizable second component may be produced. In addition, the customizable second component may not necessarily be an attachable panel(s) 100, 208a/b/c, 238, 308, 416, 430, but may instead be any type of customizable component that may be produced and generally configured with the first component. The system 500 may be used in retail stores as described above for the purchase of the first and second components, or may be used in other locations, establishments that may provide the first component and/or the ability to customize the second component for free or for other purposes other than to gain retail revenue (e.g. charities, non-profits, foundations and other organizations, businesses or individuals). In summary, the system 500 may be used with any type of product that may include a customizable component or element that may be configured with another component.

In another embodiment, artists, designers or other creative types of people may provide their artwork for customers to have printed or otherwise affixed to the front sides 130 of their attachable panels 100. In this embodiment, an artist may provide artwork to the manufacturer using means similar to described above, and the manufacturer may offer the artwork to their customers to have printed or affixed to the attachable panels 100. This embodiment may also include a sales commission that may be paid to the artist who may have provided artwork, payable when a customer may choose and order to have that specific artwork printed or otherwise affixed to their attachable panel 100. In this scenario, commissioned artists may be incentivized to market their attachable panel and carrying bag designs to their own network of fans such that the manufacturer of attachable panels 100 may also benefit from this marketing. Artist may also receive for hire payments without a sales commission, or a combination of for hire payments and sales commissions.

In another embodiment, companies or other entities may provide the manufacturer of the carrying bag 10 and attachable panel 100 with artwork that may be printed or affixed to the attachable panels 100 that may be used for advertising or marketing purposes. That is, a company may provide graphical artwork to the manufacturer of the instrument bag 10 and attachable panel 100 that may advertise the company's products or services in an aesthetically pleasing way such that a user may wish to have the graphical advertisement printed or affixed to an attachable panel 100 that may be affixed to their carrying bag 10. In this way, the user may carry the bag for others to see, and the advertisement printed on the front side 130 of the attachable panel 100 on their carrying bag 10 may provide valuable advertising for the company. In this embodiment, the company providing the advertisement graphical artwork may not only provide the artwork to the manufacturer of the bag 10 and attachable panel 100, but may also pay the manufacturer an added fee for providing the advertising means.

As stated above, graphical artwork may be printed or otherwise affixed to attachable panel 100, 208, 308 using a variety of techniques such as hand painting, silk screening, dye sublimation and other techniques.

In the case of dye sublimation, the artwork may first be printed onto paper using a dye sublimation printer. The graphical artwork may then be transferred from the printed paper to the attachable panel 100, 208, 308 by placing the paper face down onto the side of the attachable panel 100, 208, 308 that may receive the artwork, and then pressing the artwork paper and attachable panel 100, 208, 308 together at an elevated temperature and at a desired pressure to effectively melt the ink on the artwork paper and transfer the graphical image to attachable panel 100, 208, 308. It may be preferable that attachable panel 100, 208, 308 be made of a high percentage of Polyester such that the dye sublimation process may be more effective.

However, this dye sublimation process may be typically designed to work with transferring graphical images from printed artwork paper as described above to a nominally flat substrate such as a flat piece of Polyester canvas, a flat sheet of metal, a flat piece of wood, or other nominally flat substrates. The reason for this is that the dye sublimation process may be most effective in producing a consistent and well printed image when there is even and constant pressure and temperature applied across the entire printed paper and substrate combination.

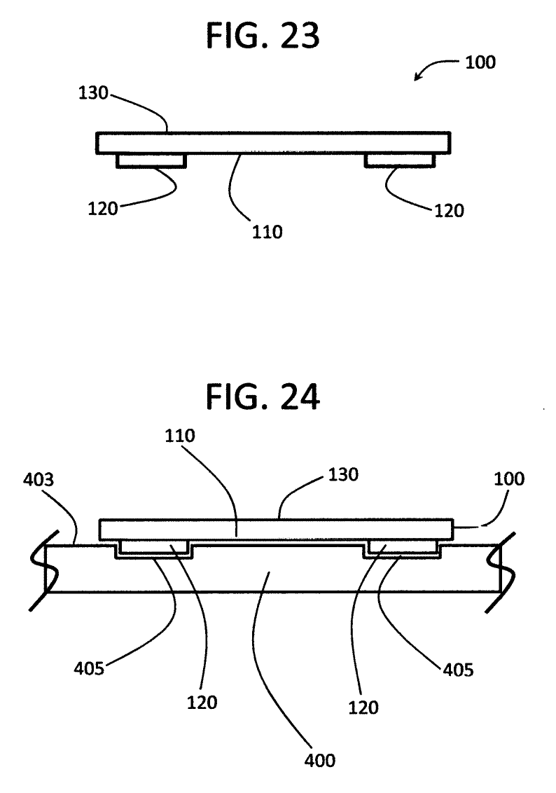

In the case of attachable panel 100, 208, 308, 416 the standard dye sublimation process may have a problem uniformly transferring the graphical images printed on the artwork paper to attachable panel 100,208,308,416 due to hook and loop section 120, 218, 408 that may be sewn onto attachable panel 100, 208, 308, 416. VELCRO section 120, 218, 420 that may be sewn onto attachable panel 100, 208, 308, 416 may cause attachable panel 100, 208, 308, 416 to not be nominally flat, but instead may cause attachable panel 100, 208, 308, 416 to have raised sections due to hook and loop section 120, 218, 420 in the areas where hook and loop section 120, 218, 420 may be sewn onto attachable panel 100, 208, 308, 416. FIG. 23 depicts this for the case of attachable panel 100 looking in the direction of arrows C of FIG. 2. This in turn may cause the dye sublimation process to have uneven pressure and temperature across the entire surface of attachable panel 100, 208, 308, 416, specifically in the areas immediately surrounding the raised areas that may be due to hook and loop section 120, 218, 420. In this case, the image being printed onto attachable panel 100, 208, 308, 416 may have inconsistencies in these areas.

It should be noted that it may be preferable that hook and loop section 120, 218, 420 be sewn onto attachable panel 100, 208, 308, 416 before the dying process such that the thread or other means used to sew or otherwise affix hook and loop section 120, 218, 420 to attachable panel 100, 208, 308, 416 may be covered by the graphical artwork that may be printed onto attachable panel 100, 208, 308 416. It may be preferable that if thread may be used to sew hook and loop section 120, 218, 420 to attachable panel 100, 208, 308, 416, that the thread may be Polyester thread such that the dye sublimation process may print more effectively on the thread. If hook and loop sections 120, 218, 420 were sewn onto attachable panel 100, 208, 308 after the graphical artwork was transferred to attachable panel 100, 208, 308, 416, the thread may cover up the artwork that may have been printed onto attachable panel 100, 208, 308, 416 in the areas where the thread may have been used to sew hook and loop section 120, 218, 420 to attachable panel 100, 208, 308, 416 which may be unsightly and less preferable.

FIG. 23 depicts one embodiment that may solve this dye sublimation problem of attachable panel 100, 208, 308, 416 having raised sections as described above. As shown in FIG. 24, a soft pad 400 may be placed underneath attachable panel 100, 208, 308, 416 with hook and loop section 120, 218, 420 resting against the top surface 402 of pad 400 such that when pressed with printed artwork paper as described above at a desired pressure and elevated temperature, hook and loop section 120, 218, 420 may be pressed into top surface 402 of pad 400 and may create small indentations 404 in top surface 402 of pad 400. This may effectively allow top surface 130 of attachable panel 100, 208, 308 to be nominally flat such that the pressure and temperature may be more consistent across the entire top surface of attachable panel 100, 208, 308, 416 such that the dye sublimation process may be more effective resulting in a higher quality graphical image.

Because each attachable panel 100, 208, 308 may be printed individually and then configured onto a carrying bag as described above, the manufacturer of carrying bags with attachable panels may not need to hold inventory of any particular graphically designed attachable panel. That is, the manufacture may only need to carry inventory of carrying bags that may be configured to receive and be configured to an attachable panel, and blank ready-to-print attachable panels that may be configured to the carrying bags. Note that the manufacturer may carry inventory of a single type of carrying bag along with attachable panels that may be configured to fit onto the single type of carrying bag, or the manufacturer may carry inventory of multiple types of carrying bags along with multiple types of attachable panels, with each type of attachable panel configured to fit onto its respective particular type of carrying bag in inventory. Then, upon an order from a customer for a particular type of carrying bag with an attachable panel containing a particular graphical design on the attachable panel, the manufacturer may print the desired particular graphical design onto the applicable blank attachable panel made for the type of carrying bag being ordered by the customer, mate the attachable panel that has been printed with the desired graphical design to the ordered carrying bag, and ship the ordered carrying bag with the mated attachable panel containing the desired graphical design to the customer.

This is in stark contrast to printing graphical designs directly onto a permanent side or multiple permanent sides of a carrying case, in which scenario the graphical designs may be a permanent element of the carrying case. In this scenario of permanent designs printed onto permanent sides of a carrying case, the manufacturer of such carrying cases may need to carry inventory of said cases as it may not be possible or financially feasible to create each carrying case individually with particular graphics on permanent sides of the carrying case. In most cases, manufacturers of carrying cases may have a minimum order quantity requirement of hundreds if not thousands of units of a particular design in order to be able to produce the product at a reasonable cost. Producing higher volume of identical graphical designed units may result in a lower and more reasonable cost per unit, and because of this, a factory may only manufacture orders of a particular graphical design if the quantity ordered is at least the minimum quantity required. This may force a manufacturer that wishes to sell carrying bags with permanent graphical sides to produce the minimum order quantity of a particular graphical design or designs in hopes that these graphical designs will be popular and will sell through.

If a manufacturer is forced to carry inventory on carrying bags with permanent graphics printed onto permanent sides of the carrying bags, the manufacturer may be at risk of the bags not being popular and not selling, or of the graphical designs falling out of popularity before the entire inventory of a particular graphical design has been sold. In these cases, the manufacturer may be forced to liquidate the unsellable inventory at a financial loss.

However, because the manufacturer that wishes to sell carrying bags with attachable panels does not need to carry inventory of a particular graphical design to be printed onto the attachable panels, the company in this scenario does not need to produce minimum quantity orders of a particular graphical design. The company only needs to produce minimum order quantities of the carrying bags configured to receive attachable panels as described above, along with minimum order quantities of blank ready-to-print attachable panels. Since these carrying bags may not contain any graphics on them, they are not in danger of falling out of style due to a graphical design, and the manufacture may not be forced to liquidate them at a financial loss.

In fact, the manufacturer of carrying bags or cases with attachable panels is able to produce particular graphically designed carrying bags and cases that may be popular on one day, and upon those graphical designs falling out of popularity, may be able to produce new and entirely different graphically designed carrying cases and bags on another day simply by choosing a new digital artwork file to print. Because the graphical designs may be digital artwork files on a computer that may be printed onto blank attachable panels whenever desired, an entire library of designs may be created and offered to the public for sale, and then printed onto blank attachable panels when ordered by a customer without having to ever carry physical inventory of any of the printed designs. This may eliminate significant financial risk compared to having to carrying physical inventory of any carrying bags with permanent graphical designs.

In addition, as described above, customers may design their own graphical designs to be printed onto the attachable panels. By producing carrying bags and cases with attachable panels instead of carrying bags with permanent graphical designs on permanent sides of the carrying case, the manufacturer may be able to print the customer's graphical design onto the attachable panel, configure the printed attachable panel onto the desired carrying bag and fulfill the order to the customer at a reasonable cost. In this scenario, the customer's graphical design may be a digital file similar to any other digital file that the manufacturer may have of any other graphical design, and thus may be printed onto a blank ready-to-print attachable panel upon the customer's order. This manufacturing process is sometimes referred to a “just in time manufacturing” or “to order manufacturing”. Conversely, if the manufacturer were manufacturing carrying bags with permanent graphics printed onto permanent sides of the carrying bags, it may not be possible or financially feasible for the manufacturer to print the customer's designed graphics onto the permanent sides of the carrying bags at a reasonable cost.

As described above, the sales revenue methods of the present invention may include on line sales of carrying bag 10 and attachable panel 100 either together or separate, brick-and-mortar retail store sales of instrument bag 10 and attachable panel 100 either together or separate, selling in-house designed attachable panels 100, selling attachable panels 100 designed by other artists, selling attachable panels 100 with designs created by customers, selling attachable panels 100 with designs created by customers using tools provided by the manufacturer, selling advertising space on the attachable panels, and other methods.

### Computing

The applications, services, mechanisms, operations, and acts shown and described above are implemented, at least in part, by software running on one or more computers.

Programs that implement such methods (as well as other types of data) may be stored and transmitted using a variety of media (e.g., computer readable media) in a number of manners. Hard-wired circuitry or custom hardware may be used in place of, or in combination with, some or all of the software instructions that can implement the processes of various embodiments. Thus, various combinations of hardware and software may be used instead of software only.

One of ordinary skill in the art will readily appreciate and understand, upon reading this description, that the various processes described herein may be implemented by, e.g., appropriately programmed general purpose computers, special purpose computers and computing devices. One or more such computers or computing devices may be referred to as a computer system.

FIG. 26 is a schematic diagram of a computer system 600 upon which embodiments of the present disclosure may be implemented and carried out.

According to the present example, the computer system 600 includes a bus 602 (i.e., interconnect), one or more processors 604, a main memory 606, read-only memory 608, removable storage media 610, mass storage 612, and one or more communications ports 614. Communication port(s) 614 may be connected to one or more networks (not shown) by way of which the computer system 600 may receive and/or transmit data.

As used herein, a “processor” means one or more microprocessors, central processing units (CPUs), computing devices, microcontrollers, digital signal processors, or like devices or any combination thereof, regardless of their architecture. An apparatus that performs a process can include, e.g., a processor and those devices such as input devices and output devices that are appropriate to perform the process.

Processor(s) 604 can be any known processor, such as, but not limited to, an Intel® Itanium® or Itanium 2® processor(s), AMD® Opteron® or Athlon MP® processor(s), or Motorola® lines of processors, and the like. Communications port(s) 614 can be any of an Ethernet port, a Gigabit port using copper or fiber, or a USB port, and the like. Communications port(s) 614 may be chosen depending on a network such as a Local Area Network (LAN), a Wide Area Network (WAN), or any network to which the computer system 600 connects. The computer system 600 may be in communication with peripheral devices (e.g., display screen 616, input device(s) 618) via Input/Output (I/O) port 620.

Main memory 606 can be Random Access Memory (RAM), or any other dynamic storage device(s) commonly known in the art. Read-only memory (ROM) 608 can be any static storage device(s) such as Programmable Read-Only Memory (PROM) chips for storing static information such as instructions for processor(s) 604. Mass storage 612 can be used to store information and instructions. For example, hard disk drives, an optical disc, an array of disks such as Redundant Array of Independent Disks (RAID), or any other mass storage devices may be used.

Bus 602 communicatively couples processor(s) 604 with the other memory, storage and communications blocks. Bus 602 can be a PCI/PCI-X, SCSI, a Universal Serial Bus (USB) based system bus (or other) depending on the storage devices used, and the like. Removable storage media 610 can be any kind of external storage, including hard-drives, floppy drives, USB drives, Compact Disc—Read Only Memory (CD-ROM), Compact Disc—Re-Writable (CD-RW), Digital Versatile Disk—Read Only Memory (DVD-ROM), etc.

Embodiments herein may be provided as one or more computer program products, which may include a machine-readable medium having stored thereon instructions, which may be used to program a computer (or other electronic devices) to perform a process. As used herein, the term “machine-readable medium” refers to any medium, a plurality of the same, or a combination of different media, which participate in providing data (e.g., instructions, data structures) which may be read by a computer, a processor or a like device. Such a medium may take many forms, including but not limited to, non-volatile media, volatile media, and transmission media. Non-volatile media include, for example, optical or magnetic disks and other persistent memory. Volatile media include dynamic random access memory, which typically constitutes the main memory of the computer. Transmission media include coaxial cables, copper wire and fiber optics, including the wires that comprise a system bus coupled to the processor. Transmission media may include or convey acoustic waves, light waves and electromagnetic emissions, such as those generated during radio frequency (RF) and infrared (IR) data communications.

The machine-readable medium may include, but is not limited to, floppy diskettes, optical discs, CD-ROMs, magneto-optical disks, ROMs, RAMs, erasable programmable read-only memories (EPROMs), electrically erasable programmable read-only memories (EEPROMs), magnetic or optical cards, flash memory, or other type of media/machine-readable medium suitable for storing electronic instructions. Moreover, embodiments herein may also be downloaded as a computer program product, wherein the program may be transferred from a remote computer to a requesting computer by way of data signals embodied in a carrier wave or other propagation medium via a communication link (e.g., modem or network connection).

Various forms of computer readable media may be involved in carrying data (e.g. sequences of instructions) to a processor. For example, data may be (i) delivered from RAM to a processor; (ii) carried over a wireless transmission medium; (iii) formatted and/or transmitted according to numerous formats, standards or protocols; and/or (iv) encrypted in any of a variety of ways well known in the art.

A computer-readable medium can store (in any appropriate format) those program elements which are appropriate to perform the methods.

As shown, main memory 606 is encoded with application(s) 622 that support(s) the functionality as discussed herein (the application(s) 622 may be an application(s) that provides some or all of the functionality of the services/mechanisms described herein, e.g., the system 500, backend 502, POPs 506 and the app 510 as depicted in FIG. 25). Application(s) 622 (and/or other resources as described herein) can be embodied as software code such as data and/or logic instructions (e.g., code stored in the memory or on another computer readable medium such as a disk) that supports processing functionality according to different embodiments described herein.

During operation of one embodiment, processor(s) 604 accesses main memory 606 via the use of bus 602 in order to launch, run, execute, interpret or otherwise perform the logic instructions of the application(s) 622. Execution of application(s) 622 produces processing functionality of the service related to the application(s). In other words, the process(es) 624 represent one or more portions of the application(s) 622 performing within or upon the processor(s) 604 in the computer system 600.

For example, process(es) 604 may include a data handshake between a manufacturer and a retailer via the system 500, backend 502, POPs 506 and the app 510 as depicted in FIG. 25.

It should be noted that, in addition to the process(es) 624 that carries(carry) out operations as discussed herein, other embodiments herein include the application 622 itself (i.e., the un-executed or non-performing logic instructions and/or data). The application 622 may be stored on a computer readable medium (e.g., a repository) such as a disk or in an optical medium. According to other embodiments, the application 622 can also be stored in a memory type system such as in firmware, read only memory (ROM), or, as in this example, as executable code within the main memory 606 (e.g., within Random Access Memory or RAM). For example, application(s) 622 may also be stored in removable storage media 610, read-only memory 608, and/or mass storage device 612.

Those skilled in the art will understand that the computer system 600 can include other processes and/or software and hardware components, such as an operating system that controls allocation and use of hardware resources. For example, as shown in FIG. 18, the computer system 600 may include one or more sensors 626.

As discussed herein, embodiments of the present invention include various steps or operations. A variety of these steps may be performed by hardware components or may be embodied in machine-executable instructions, which may be used to cause a general-purpose or special-purpose processor programmed with the instructions to perform the operations. Alternatively, the steps may be performed by a combination of hardware, software, and/or firmware. The term “module” refers to a self-contained functional component, which can include hardware, software, firmware or any combination thereof.

One of ordinary skill in the art will readily appreciate and understand, upon reading this description, that embodiments of an apparatus may include a computer/computing device operable to perform some (but not necessarily all) of the described process.

Embodiments of a computer-readable medium storing a program or data structure include a computer-readable medium storing a program that, when executed, can cause a processor to perform some (but not necessarily all) of the described process.

Where a process is described herein, those of ordinary skill in the art will appreciate that the process may operate without any user intervention. In another embodiment, the process includes some human intervention (e.g., a step is performed by or with the assistance of a human).

Although some embodiments hereof are described using an integrated device (e.g., a smartphone), those of ordinary skill in the art will appreciate and understand, upon reading this description, that the approaches described herein may be used on any computing device that includes a display.

As used herein, including in the claims, the phrase “at least some” means “one or more,” and includes the case of only one. Thus, e.g., the phrase “at least some ABCs” means “one or more ABCs”, and includes the case of only one ABC.

As used in this description, the term “portion” means some or all. So, for example, “A portion of X” may include some of “X” or all of “X”. In the context of a conversation, the term “portion” means some or all of the conversation.

As used herein, including in the claims, the phrase “based on” means “based in part on” or “based, at least in part, on,” and is not exclusive. Thus, e.g., the phrase “based on factor X” means “based in part on factor X” or “based, at least in part, on factor X.” Unless specifically stated by use of the word “only”, the phrase “based on X” does not mean “based only on X.”

As used herein, including in the claims, the phrase “using” means “using at least,” and is not exclusive. Thus, e.g., the phrase “using X” means “using at least X.” Unless specifically stated by use of the word “only”, the phrase “using X” does not mean “using only X.”

In general, as used herein, including in the claims, unless the word “only” is specifically used in a phrase, it should not be read into that phrase.

As used herein, including in the claims, the phrase “distinct” means “at least partially distinct.” Unless specifically stated, distinct does not mean fully distinct. Thus, e.g., the phrase, “X is distinct from Y” means that “X is at least partially distinct from Y,” and does not mean that “X is fully distinct from Y.” Thus, as used herein, including in the claims, the phrase “X is distinct from Y” means that X differs from Y in at least some way.

It should be appreciated that the words “first” and “second” in the description and claims are used to distinguish or identify, and not to show a serial or numerical limitation. Similarly, the use of letter or numerical labels (such as “(a)”, “(b)”, and the like) are used to help distinguish and/or identify, and not to show any serial or numerical limitation or ordering.

No ordering is implied by any of the labeled boxes in any of the flow diagrams unless specifically shown and stated. When disconnected boxes are shown in a diagram the activities associated with those boxes may be performed in any order, including fully or partially in parallel.

Thus is provided an augmented reality system that combines a live view of a real-world, physical environment with imagery based on live images from one or more other devices.

While the invention has been described in connection with what is presently considered to be the most practical and preferred embodiments, it is to be understood that the invention is not to be limited to the disclosed embodiment, but on the contrary, is intended to cover various modifications and equivalent arrangements included within the spirit and scope of the appended claims.

The present invention Includes a number of aspects and features which may be practiced alone or in various combinations or sub-combinations, as desired. While preferred embodiments of the present invention have been disclosed and described herein for purposes of illustration and not for purposes of limitation, it will be understood by those skilled in the art that various changes in form and detail may be made therein without departing from the spirit and scope of the invention.

What is claimed is:

1. A bag configured to carry items, comprising:
a surface;
at least one first attachment mechanism configured with the surface;
at least one attachable panel;
at least one second attachment mechanism configured with the attachable panel;
wherein the at least one first attachment mechanism and the at least one second attachment mechanism are engaged to configure the at least one attachable panel to the surface.

2. The bag of claim 1 further comprising a reinforcement structure.

3. The bag of claim 2, wherein the reinforcement structure is configured with the surface.

4. The bag of claim 1 wherein the at least one first attachment mechanism and the at least one second attachment mechanism are snaps.

5. The bag of claim 1 wherein the at least one first attachment mechanism and the at least one second attachment mechanism are hook and loop material.

6. The bag of claim 1 wherein the at least one second attachment mechanism is a double-sided attachment mechanism.

7. The bag of claim 6 wherein the at least one attachable panel is double-sided.

8. The bag of claim 1 wherein the at least one attachable panel includes graphical images.
